(19) United States
(12) Patent Application Publication
(10) Pub. No.: US 2026/0268442 A1
(43) Pub. Date: Sep. 10, 2026

(54) DEEP LEARNING SUPER RESOLUTION OF MEDICAL IMAGES

(71) Applicant: The Trustees of the University of Pennsylvania, Philadelphia, PA (US)

(72) Inventors: Chamith Sudesh Rajapakse, Cherry Hill, NJ (US); Trevor Jackson Chan, Philadelphia, PA (US)

(21) Appl. No.: 18/849,467

(22) PCT Filed: Mar. 23, 2023
(86) PCT No.: PCT/US2023/016109

§ 371 Date: Sep. 20, 2024

Related U.S. Application Data
(60) Provisional application No. 63/323,047, filed on Mar. 23, 2022.

(51) Int. Cl. G06T 3/4053; G06T 3/4046; G06T 5/60; G06T 5/70; G06T 7/00

(52) U.S. Cl. CPC G06T 3/4053; G06T 3/4046; G06T 5/60; G06T 5/70; G06T 7/0012; G06T 2207/10081; G06T 2207/10088; G06T 2207/10104; G06T 2207/10116; G06T 2207/10132; G06T 2207/20016; G06T 2207/20081; G06T 2207/20084; G06T 2207/30008

(57) ABSTRACT

A method for super-resolution processing of medical images includes receiving, as input, a medical image of a modality and a first resolution. The method further includes concatenating the medical image with a noise vector of a desired resolution higher than the first resolution. The method further includes passing the noise vector concatenated with the medical image though a neural network trained to remove noise and treating an output of the neural network as a new noise vector to be concatenated with the medical image and passed through the neural network. The method further includes repeating the concatenating and passing steps a plurality of times to produce, an image output from the neural network which comprises a super-resolution version of the medical image having the desired resolution.

### PRIORITY CLAIM

This application claims the priority benefit of U.S. Provisional Patent Application Ser. No. 63/323,047, filed Mar. 23, 2023, the disclosure of which is incorporated herein by reference in its entirety.

### GOVERNMENT INTEREST

This invention was made with government support under AR076392 and AR068382 awarded by the National Institutes of Health and 2026906 awarded by the National Science Foundation. The government has certain rights in the invention.

### TECHNICAL FIELD

The subject matter described herein relates to image processing. More particularly, the subject matter described herein relates to using deep learning to increase the resolution of medical images of different imaging modalities.

### BACKGROUND

Obtaining high-resolution medical imaging can be important in diagnosing and treating subjects. However, high-resolution medical imaging is time consuming, and, depending on the modality, can increase the radiation exposure to the patient. As a result, it may be desirable to obtain low resolution imaging, such as magnetic resonance (MR), computed tomography (CT), positron emission tomography (PET), and ultrasound imaging and computationally increase the resolution of the images. Existing methods for computationally increasing the resolution of medical images suffer from drawbacks, such as texture smoothing and mode collapse, that decrease the accuracy of the upsampled image.

In light of these and other difficulties, there exists a need for improved methods, systems, and computer readable media for increasing the resolution of medical images.

### SUMMARY

A method for super-resolution processing of medical images includes receiving, as input, a medical image of a modality and a first resolution. The method further includes concatenating the medical image with a noise vector of a desired resolution higher than the first resolution. The method further includes passing the noise vector concatenated with the medical image though a neural network trained to remove noise and treating an output of the neural network as a new noise vector to be concatenated with the medical image and passed through the neural network. The method further includes repeating the concatenating and passing steps a plurality of times to produce an image output from the neural network which comprises a super-resolution version of the medical image having the desired resolution.

According to another aspect of the subject matter described herein, the modality is computed tomography (CT).

According to another aspect of the subject matter described herein, the modality is magnetic resonance (MR).

According to another aspect of the subject matter described herein, the modality is positron emission tomography (PET).

According to another aspect of the subject matter described herein, the modality is ultrasound.

According to another aspect of the subject matter described herein, the modality is x-ray.

According to another aspect of the subject matter described herein, the trained neural network comprises a U-Net encoder decoder with skip connections.

According to another aspect of the subject matter described herein, the neural network implements a denoising diffusion probabilistic model (DDPM).

According to another aspect of the subject matter described herein, repeating steps (b) and (c) a plurality of times includes repeating steps (b) and (c) a number of times based on a number of iterations required to achieve a desired value of a loss function during training of the neural network.

According to another aspect of the subject matter described herein, the method includes generating a measurement of a property of an anatomical region depicted in the super-resolution image.

According to another aspect of the subject matter described herein, the anatomical region comprises a bone and generating the measurement of the property is achieved using finite element analysis.

According to another aspect of the subject matter described herein, a system for super-resolution processing of medical images is provided. The system includes at least one processor. The system further includes a super-resolution image generator implemented by the at least one processor for receiving, as input, a medical image of a modality and a first resolution, concatenating the medical image with a noise vector of a desired resolution higher than the first resolution, passing the noise vector concatenated with the medical image though a neural network trained to remove noise and treating an output of the neural network as a new noise vector for use as the noise vector, and repeating the concatenating and passing a plurality of times to produce an image output from the neural network which comprises a super-resolution version of the medical image having the desired resolution.

According to another aspect of the subject matter described herein, the system includes an anatomical structure mechanical property quantifier for generating a measurement of a mechanical property of an anatomical structure depicted in the super-resolution image.

According to another aspect of the subject matter described herein, a non-transitory computer readable medium comprising computer executable instructions that when executed by a processor of a computer control the computer to perform the steps is provided. The steps include receiving, as input, a medical image of a modality and a first resolution. The steps further include concatenating the medical image with a noise vector of a desired resolution higher than the first resolution. The steps further include passing the noise vector concatenated with the medical image though a neural network trained to remove noise and treating an output of the neural network as a new noise vector for use as the noise vector in step (b). The steps further include repeating steps (b) and (c) a plurality of times to produce an image output from the neural network which comprises a super-resolution version of the medical image having the desired resolution.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF DRAWINGS

FIG. 1 illustrates a comparison between an original image, bicubic upsampling, and diffusion model upsampling demonstrates the model's ability to reconstruct fine trabecular architecture in images of the proximal femur. The scale bar is 10 mm.

FIG. 2 illustrates an exemplary model architecture. An initial 256×256 noise vector x_{T} is concatenated with a low resolution image (y₀; original 64×64 interpolated to 256×256) and passed through an U-Net encoder decoder with skip connections. The decoder output xₜ₋₁ is considered the new noise vector. This process repeats for 2000 steps to obtain x₀, the model prediction for the original image. Layers of the U-Net consist of Resnets (red) and Resnets with added self attention layers (purple).

FIG. 3 illustrates in part (a) additional images sampled at various cross sections of the femur demonstrate similar ability to reconstruct fine detail in cortical and trabecular bone. Part (b) in FIG. 3 illustrates the diffusion process: a low resolution input image, an initial noise vector (t=T), and a gradual recovery of image signal as t goes to 0. Images are sampled at increments of 200 time steps. The scale bar is 10 mm.

FIG. 4 (Top) illustrates the forwarding noising process beginning from a high resolution image at time t=0 and ending with complete noise at t=T. FIG. 4 (Bottom) illustrates the reverse noising process begins from a complete noise vector x_{T} and a conditional low resolution input y and produces a high resolution image x₀;

FIG. 5 illustrates a comparison between an original MRI slice of the tibia, a bicubic downsampled image, and the model unsampled image demonstrates the model's ability to reconstruct the fine trabecular architecture in images of the distal tibia. The top scale bar is 10 mm. The enlarged (bottom) scale bar is 1 mm.

FIG. 6 illustrates a 3D cross-sectional view of the tibia: ground truth high-resolution MRI (left), the same dataset at a lower resolution after downsampling (middle), and the model output (right). 3D image stacks are constructed from individual 2D slices. In the case of the low resolution input and model output, blur and blur plus sample operations are performed in 2D before 3D accumulation.

FIG. 7 illustrates an overview of the methodology described herein.

FIG. 8 is a series of images illustrating noising in the forward and reverse directions.

FIG. 9 is a series of images comparing different methods for increasing image resolution.

FIG. 10 illustrates examples of bone morphology measurements that can be produced from the super-resolution images produced using the methodology described herein.

FIGS. 11A and 11B illustrate results of comparing five reconstruction methods across four trabecular microstructural parameters, over three regions of the proximal femur.

FIGS. 12A and 12B illustrate mechanical stiffness calculated by finite element analysis [41], compared across five reconstruction methods. In FIG. 12A reconstruction is plotted against ground truth, with the gray line denoting perfect agreement.

FIGS. 13A and 13B compare image reconstruction methods using metrics of image quality.

FIG. 14 illustrates an exemplary model architecture and training of the model to produce higher resolution images from lower resolution medical images.

FIGS. 15A and 15B illustrate results of a Bland-Altman analysis comparing performance of our model with the next highest performing model, the SRGAN.

FIG. 16 illustrates image quality assessment metrics compared to trabecular structural metrics.

FIG. 17 illustrates physiological metrics calculated by region and by subject.

FIG. 18 is a block diagram illustrating an exemplary computing environment for producing super-resolution medical images from low resolution medical images using the methods described herein.

FIG. 19 is a flow chart illustrating an exemplary process for implementing super-resolution medical images from low resolution medical images using the subject matter described herein.

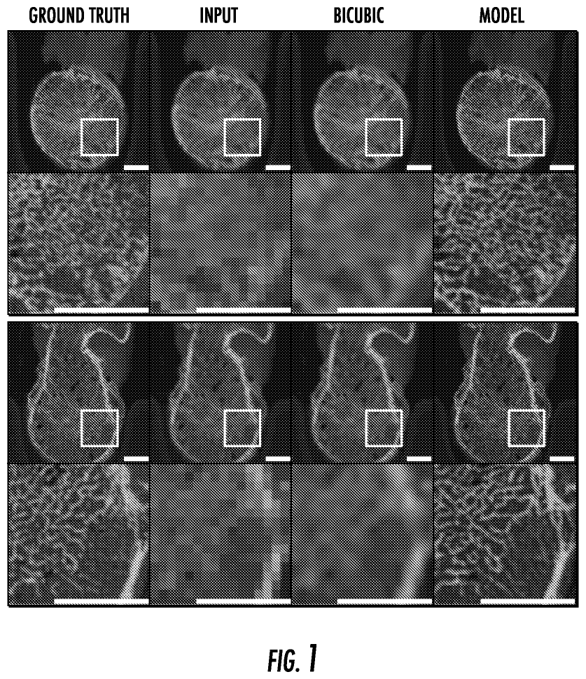

### DETAILED DESCRIPTION

### CT Super-Resolution Using Diffusion Probabilistic Models

In this section, we introduce CTURN, a probabilistic deep learning model to perform image super-resolution on CT femur images. Compared to existing deep learning methods for image super-resolution, our method achieves competitive image quality while avoiding common serious pitfalls, namely mode collapse and model instability. Results show that our model is able to reconstruct fine details of cortical and trabecular bone architecture from low resolution images (upsample factor=4). By increasing image quality and decreasing scan time and radiation dose, these methods show great potential for clinical use across a variety of imaging modalities.

### 1. Introduction

High resolution CT (HRCT) and ultra-high resolution CT (UHRCT) scanning has demonstrated potential in a variety of clinical applications. HRCT of the lungs is already standard practice; here, higher scanning resolution is shown to increase image quality and diagnostic accuracy [1, 2]. In imaging bone, HRCT and U-HRCT allows for the visualization of fine details in cortical and trabecular architecture, and can be used for assessment of osteoporosis, and even prediction of mechanical strength and fracture [3, 4]. Despite the value of the resulting images, these methods face a few significant drawbacks compared to conventional CT. Increasing image quality—either via the reduction of noise or via increasing scanning resolution—is commonly achieved through increasing the sample number, and by extension, scanning time and radiation dose. This tradeoff is not unique to CT imaging, but here it is especially pronounced due to the reliance on ionizing radiation. Computational methods for image upsampling escape this tradeoff; they allow for an increase in image quality without the concomitant increase in radiation and scanning time.

Multiple approaches have been proposed for the task of medical image super-resolution, including both sparsity-based models (i.e., compressive sensing) and data-driven models. Among these, deep neural networks have emerged as an effective and computationally efficient method for image reconstruction and super-resolution. These models take advantage of highly parallel GPU architectures to decrease computation time and achieve high performance on a range of image processing tasks, including image segmentation, image generation, and image upsampling.

Common approaches to image upsampling include a variety of deep convolutional networks and, more recently, generative adversarial networks (GANs) to achieve state-of-the-art image quality [5]. The latter of these have demonstrated near photorealistic results in large image datasets but are known to suffer from a few serious drawbacks. These include model instability and mode collapse: unwanted model behavior in which the diversity of generator outputs is significantly less than the diversity of the training data. In practice, this often means the model learns to only replicate common inputs and to ignore uncommon data. In medical data processing, mode collapse is especially dangerous as uncommon features-possibly indicative of pathology-take on an outsized importance.

### 2. Probabilistic Approach

We address the main concern of GAN architectures, mode collapse, by employing a denoising diffusion probabilistic model (DDPM) for image generation. Diffusion probabilistic models were first described by [6] in 2015 but have recently garnered attention for their application to image generation and for improvements in image quality [7, 8, 9]. In 2021, [10] showed excellent results applying denoising diffusion models to image super-resolution on general image datasets. We adapt this class of model to perform upsampling on low resolution cadaveric femur CT images. We call our method CTURN; Computed Tomography Upsampling via Reverse Noising.

Creation of the diffusion model involves first defining a forward diffusion process of length T. Following [7, 10], we define the operation q as the gradual addition of Gaussian noise to an image x₀:

$$q ( {x}_{1 : T} \vert {x}_{0} ) := {\prod }_{t = 1}^{T} q ( {x}_{t} \vert {x}_{t - 1} ) \\ where \\ q ( {x}_{t} \vert {x}_{t - 1} ) := 𝒩 ( {x}_{t} ; \sqrt{1 - {β}_{t}} {x}_{t - 1} , {β}_{t} I )$$

and βt is a parameter that controls noise variance and is defined from 0<t≤T. T and β are chosen such that x_{T} is essentially complete Gaussian noise. Also note that x₀ is the original denoised image.

Here, our goal is to learn a process p_{θ} that reverses the diffusion process q. As with the iterative process q, p_{θ} is broken into T steps:

$${p}_{θ} ( {x}_{0 : T} ) := p ( {x}_{T} ) {\prod }_{t = 1}^{T} {p}_{θ} ( {x}_{t - 1} \vert {x}_{t} ) \\ where \\ {p}_{θ} ( {x}_{t - 1} \vert {x}_{t} ) := 𝒩 ( {x}_{t - 1} ; {μ}_{θ} ( {x}_{t} , t ) , {σ}_{θ} ( {x}_{t} , t ) )$$

A single step of this process p_{θ}(xₜ₋₁|xₜ) is modeled using a deep neural network. We adapt the SR3 architecture [10,11] to model the process p_{θ}. This model consists of a Unet encoder-decoder with a resnet backbone trained to remove a small, set amount of noise from an image. By repeating this process T times (T=2000), and optionally adding a low-resolution image y as model conditional information p_{θ}(xₜ₋₁|xₜ, y) we can achieve both unconditional image generation and conditional image upsampling.

Following [7, 10], we calculate losses by comparing steps of the forward process q to the modeled reverse process p_{θ} and minimizing the MSE of

$${E}_{θ} ( {x}_{t - 1} \vert {x}_{t} , t , y ) , \\ E ( {x}_{t} \vert {x}_{t} - 1 )$$

where E_{θ} is the distribution of Gaussian noise removed by p_{θ} at step t and E is the distribution of Gaussian noise added by q at step t.

Importantly, as each step is stochastic in nature, this entire process is probabilistic. Samples are drawn from the target posterior rather than the mean of the posterior, as is commonly done by CNNs optimizing on MSE. This also gives the model an advantage over GANs, as it is comparatively resilient to mode collapse and to mismatching of the generated image to the conditional image.

### 3. CT Image Data and Preparation

The data used in this experiment was obtained using HRpqCT imaging of 10 human cadaveric femurs at isotropic 30 μm resolution. Together, they amount to 29,000 cross sectional bone images. At training, we use a bilinear down-sample operation to obtain a spatial resolution of 480 μm at a pixel count of 256². This is considered the ground truth image. For model inputs, we further down-sample using bicubic interpolation to obtain a spatial resolution of 1920 μm at a pixel count of 64². To evaluate model performance, we compare the ground truth image at 1 px=480² μm² and the generated image at the same resolution. The pixel counts in this section and in the corresponding section below for MR images are intended for illustrative purposes only. The methodology described herein can be used to increase the resolution of images with a pixel count of N to a pixel count of M, where N and M are integers and M>N.

### 4. Discussion

With CTURN, we demonstrate that diffusion probabilistic models are capable of improving image quality of CT bone scans. In clinical use, these methods would allow for a significant gain in image quality and a degree of undersampling, with a corresponding reduction in both scan time and radiation dose. The key advantage of this class of probabilistic models is their ability to accurately mirror the training data distribution, reducing the risk that uncommon but crucial information is erased in post-processing.

Despite this, DDPM models, like all data-driven models, are still subject to bias introduced in the selection of training data. Therefore, it is critically important that training datasets comprise a diverse and representative set of patients, and include a diverse and representative set of healthy and pathological conditions.

Also of note, these models incur a much higher computational cost at inference compared to GANs or CNNs due to the many iterations an image goes through during refinement. Consequently, runtime at inference is many times longer. In practice, we measure conditional image super-resolution from 64² to 256² on a V100 to take 207 seconds. Overall, our method achieves high performance and has significant advantages compared to leading deep learning models for medical image super-resolution.

### Deep Learning Super-Resolution of MR Images of the Distal Tibia Improves Image Quality and Assessment of Bone Microstructure

### Synopsis

In this section, we apply a probabilistic deep learning model to perform image super-resolution on magnetic resonance (MR) images. Our results show that the model is capable of high performance in MR; we upsample low resolution images of the distal tibia to 2× initial spatial resolution-equivalent to capturing 4× fewer samples in K-space—with the goal of reconstructing details in the trabecular architecture. We validate our results by comparing trabecular bone microstructure metrics across high-resolution ground truth, mode-reconstructed, and low-resolution input images. By drastically reducing scan time for high-resolution imaging, these methods have the potential to make MRI assessment of bone strength clinically viable.

### Introduction

Assessment of the structural integrity of bone is clinically important for predicting risk of fracture. Dual energy absorptiometry (DXA) is the clinical gold-standard for evaluating bone mineral density. However, DXA has a high specificity and low sensitivity (<50%) [12]. The importance of establishing an effective screening tool for bone fragility cannot be understated—within one year of a hip fracture, 50% of patients cannot walk and 20-30% do not survive [13, 14]. Recent advances have used finite element analysis of cortical and trabecular bone to accurately assess mechanical competence from MR images [15-18].

Despite increased accuracy, these methods require high-resolution, long scan-time images, limited clinical viability. Computational super-resolution presents a potential escape from the resolution-scan time tradeoff. Among deep learning super-resolution methods, convolutional neural networks (CNNs) and generative adversarial networks (GANs) dominate but suffer from a range of well documented drawbacks including texture-smoothing and mode collapse [19,20]. We present an alternative probabilistic deep learning approach and investigate the feasibility of its application to super-resolution on undersampled images of the tibia. We evaluate mode performance by comparing trabecular bone microstructural parameters across ground truth high-resolution, model, and low-resolution images [15, 16, 18].

### Methods

This study uses microstructural MR images of the distal tibia of 90 postmenopausal women (mean age=65.1±5.7 years) acquired on a 3 T scanner (Siemens Tim Trio, Erlangen, Germany) using a 3D spin-echo sequence and 4-channel surface coil at 0.137 mmx 0.137 mm×0.419 mm voxel size. We perform a bicubic downsample prior to training to obtain a 0.246 mm×0.246 mm×0.410 mm voxel size, which we consider ground truth resolution. We further downsample to % of ground truth spatial resolution to obtain our low resolution input.

We employ a denoising diffusion probabilistic model for image generation. Diffusion probabilistic models have recently garnered attention for their application to image generation and for improvements in image quality [7-9]. In 2021, Saharia et al. showed excellent results applying denoising diffusion models to image upsampling on general image datasets¹³. We adapt this class of model to perform super-resolution on low resolution MR images.

Creation of the diffusion model involves first defining a forward diffusion process of length T. Following Ho et al. [7], we define the operation q as the gradual addition of Gaussian noise to an image x₀:

$$q ( {x}_{1 : T} \vert {x}_{0} ) := {\prod }_{t = 1}^{T} q ( {x}_{t} \vert {x}_{t - 1} ) \\ where \\ q ( {x}_{t} \vert {x}_{t - 1} ) := 𝒩 ( {x}_{t} ; {x}_{t - 1} \sqrt{1 - {β}_{t}} , {β}_{t} I )$$

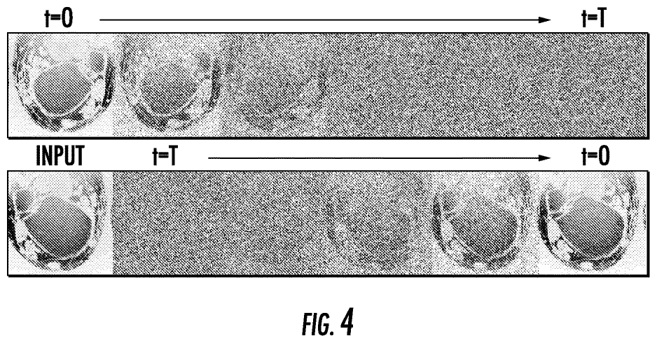

and β, is a parameter that controls noise variance and is defined from 0<t≤T. T and μ are chosen such that x_{T} is essentially complete Gaussian noise. Also note that x₀ is the original denoised image (FIG. 4 top). Here, our goal is to learn a process po that reverses the diffusion process q. As with the iterative process q, p_{θ} is broken down into T steps:

$${p}_{θ} ( {x}_{0 : T} ) := p ( {x}_{T} ) {\prod }_{t = 1}^{T} {p}_{θ} ( {x}_{t - 1} \vert {x}_{t} ) \\ where \\ {p}_{θ} ( {x}_{t - 1} \vert {x}_{t} ) := 𝒩 ( {x}_{t - 1} ; {μ}_{θ} ( {x}_{t} , t ) , {σ}_{θ} ( {x}_{t} , t ) )$$

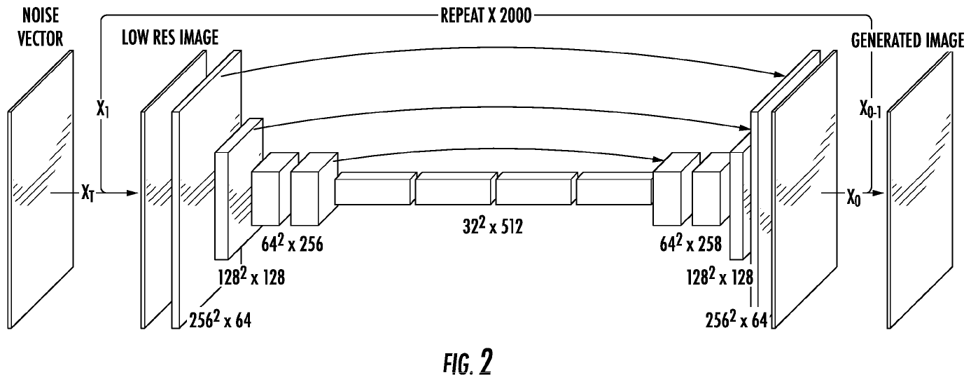

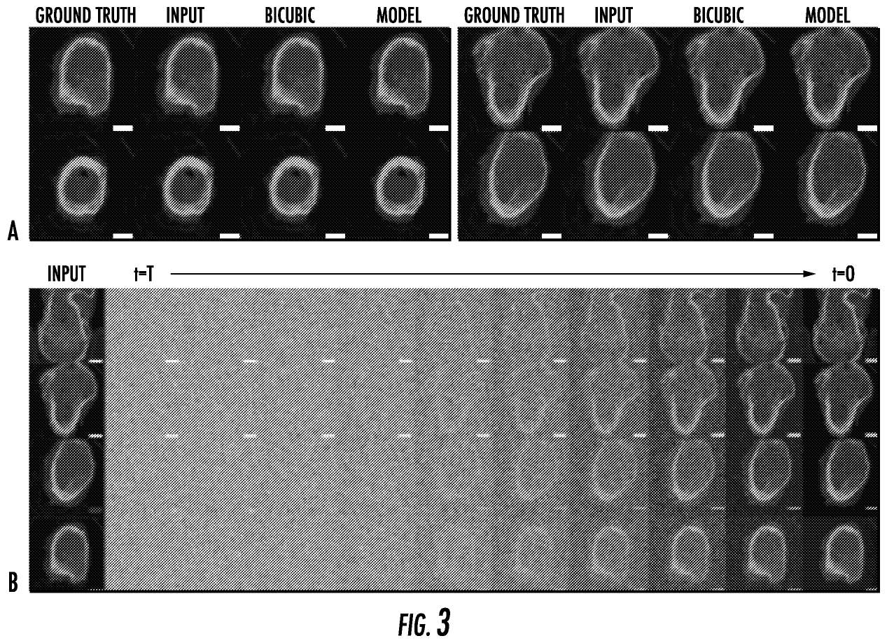

A single step of this process p_{θ}(xₜ₋₁|xₜ) is modeled using a deep neural network (FIG. 4 (bottom)). We adapt the SR3 architecture to model the process p_{θ}. This model consists of a U-net encoder-decoder with a resnet backbone trained to remove small, set amount of noise from an image. By repeating this process T times (T=2000), and optionally adding a low-resolution image y as a model conditional information p_{θ}(xₜ₋₁|xₜ, y) we can achieve both unconditional image generation and conditional image super-resolution (FIG. 2).

We additionally quantify the trabecular bone volume fraction (BV/TV), trabecular thickness (TbTh), trabecular number (TbN), and trabecular spacing (TbS) of one subject for three image types: high-resolution, model-reconstructed, and low-resolution images. We compute BV/TV and TbTh using a fuzzy distance transform algorithm and derive TbN and TbS following Saha et al. [21, 22].

### Results

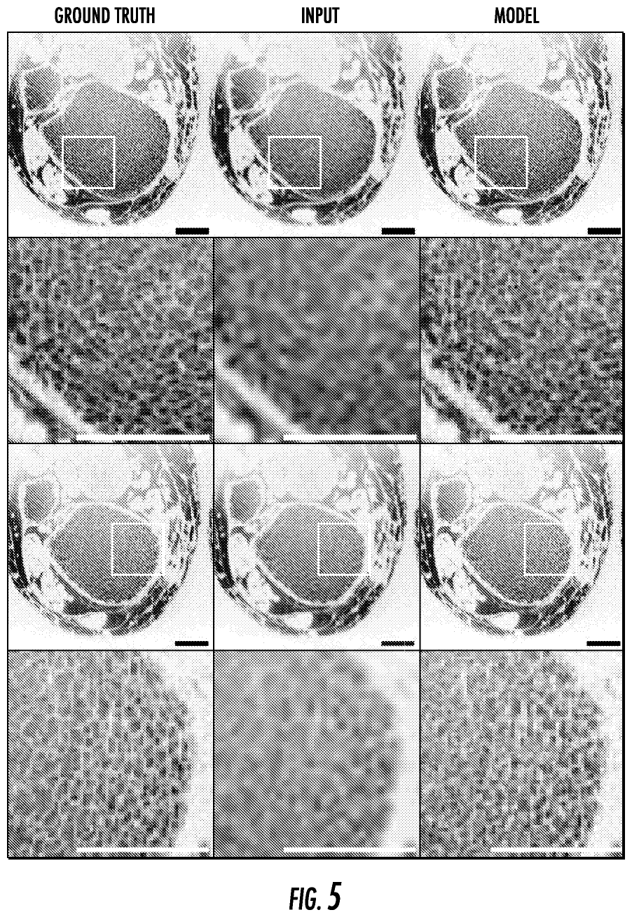

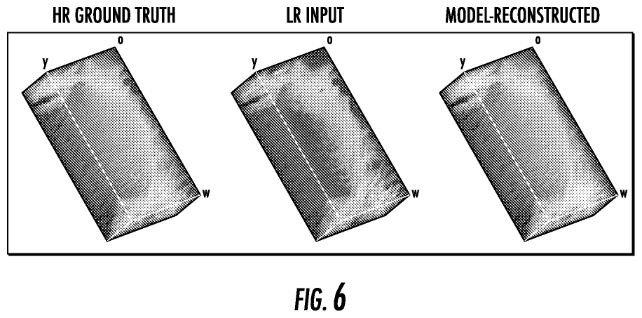

We evaluated model performance visually and quantitatively with a set of trabecular bone microstructural parameters, defined above. FIG. 5 and FIG. 6 compare high-resolution, model-reconstructed, and low-resolution images in 2D and 3D. Considering the high-resolution images as ground truth, we found a drastic reduction in error for model-reconstructed outputs compared to the low-resolution inputs across all metrics (Table 1).

TABLE 1
We quantify the 3D trabecular structure for one subject from high
resolution, low resolution, and model-upsampled images from one
subject. For bone volume fraction (BV/TV), trabecular thickness
(TbTh), trabecular number (TbN), and trabecular spacing (TbS),
the model demonstrates greater similarity to the high-resolution
ground truth compared to the downsampled input images.

| | | | | | BV/TV | TbTh | TbN | TbS |
|---|---|---|---|---|---|---|---|---|
| Image | | TbTh | TbN | TbS | Error | Error | Error | Error |
| Quality | BV/TV | (mm) | (mm⁻¹) | (mm) | (%) | (%) | (%) | (%) |
| High | 0.074 | 0.128 | 0.574 | 1.614 | | | | |
| Res | | | | | | | | |
| Model | 0.076 | 0.126 | 0.606 | 1.527 | 3.6 | −1.7 | 5.4 | −5.4 |
| Low | 0.034 | 0.122 | 0.279 | 3.469 | −52.1 | −5.3 | −48.9 | 121.5 |
| Res | | | | | | | | |

### Discussion

We achieve promising results using a probabilistic deep learning model for MR super-resolution on undersampled tibia images. We evaluate reconstruction quality using four metrics of trabecular bone microstructure, which collectively serve as an indicator of bone strength. According to these measurements, the model-constructed images more closely match the ground truth images than do the low-resolution input images, indicating substantial improvement (Table 1).

This model, like other data-driven models, is susceptible to bias introduced in the selection of training data. In order to assess the clinical value of these methods, future research must consider large, representative datasets comprising healthy and pathological images. Additionally, we perform our analysis in the image domain and not on raw frequency data. Future work will investigate the effect of alternate downsampling functions (i.e., a box filter imposed in the frequency domain), alternate noising functions (particularly Rician) and performing upsampling in the frequency domain on performance. Nevertheless, our results show promise for faithfully recovering the fine trabecular architecture from low-resolution scans. These findings suggest that computationally upsampled high-resolution MR images are a clinically viable method for assessment of bone strength.

Probabilistic Deep Learning Model for Recovering Bone Microstructure from Low Resolution CT Images

This section discusses the use of the above-described deep learning model to generate high-resolution images from low resolution images and, from the high-resolution images, determining indications of bone morphology and finite element calculations.

Subtle changes in trabecular microstructure can have drastic effects on the overall mechanical strength of bone. Despite this, changes at this length scale are undetectable by current clinical imaging methods due to constraints on ionizing radiation dose. As a result, visualizing the anatomical microstructure of bone and assessing changes over time cannot be accomplished reliably in live patients. To circumvent this limitation, we used a probabilistic deep learning model trained on high resolution cadaveric CT scans to recover bone microstructure from low resolution images of the proximal femur, a common site of traumatic osteoporotic fractures. Spatial resolution in these images is increased threefold, from 0.72 mm to 0.24 mm, sufficient to visualize bone microstructure. We validated our results using microstructural metrics and finite element simulation-derived stiffness of trabecular bone regions. Compared to popular deep learning baselines, our model exhibited greater accuracy and lower bias across these physiological metrics. Finally, we computed performance across a handful of image quality assessment metrics. We identified two metrics: gradient magnitude similarity mean and gradient structural similarity, which strongly correlated with accuracy across structural and mechanical criteria, making them well suited for evaluating image reconstruction in highly detailed bone imaging applications. Our method enables accurate measurements of bone structure and strength with a radiation dose on par with current clinical imaging protocols, improving the viability of clinical CT for assessing bone health.

### 1. Introduction

Diagnosis and assessment of osteoporosis is typically performed through dual energy X-ray absorptiometry (DXA), but 20 DXA imaging is known to have a low sensitivity (<50%) when predicting osteoporotic fracture [23]. The low predictive power of DXA is largely due to its inherent limitations: because DXA acquires only a low resolution 2D projection, it reveals little structural information and cannot distinguish between trabecular and cortical bone. It therefore provides an incomplete picture of bone mechanics [24]. A promising alternative approach is to evaluate bone health using high resolution imaging, either CT or MRI. In bone, CT imaging can provide additional valuable information lacking in DXA scans, such as overall 3D structure, cortical bone density, and even detailed trabecular microstructure at peripheral skeletal sites. This information can be used to accurately assess osteoporosis progression, estimate bone strength, and predict bone fracture risk [3, 4, 25]. Trabecular microstructure and trabecular stiffness in particular have been shown to be better measures of bone health in osteoporotic individuals than DXA-derived bone mineral density [26, 27, 28, 29].

Promising imaging methods include the use of high resolution peripheral quantitative CT (HR-pQCT) or peripheral multidetector row CT (MDCT) imaging [30, 31]. The information gained through high resolution scanning comes at a steep cost: increasing resolution necessarily increases the subject's radiation dose. In cases of osteoporosis, where patients may need to receive multiple follow up scans over their lifetimes and the danger posed by the disease is not considered urgent, the risks of increased radiation outweigh the benefits. For this reason, use of both HR-pQCT and MDCT for microstructural bone imaging is limited to peripheral regions—the wrist and the ankle—where abdominal and pelvic organs are not at risk. Despite this, the most common and most serious osteoporotic fractures occur in the hip and spine, and imaging, even very detailed imaging, of the peripheral skeleton only offers an approximation of bone health in the central skeleton [32].

Using computational super-resolution techniques, we can sidestep constraints imposed by radiation by acquiring lower-resolution images on standard, large bore clinical scanners and inferring the necessary detailed information. In addition to improving the quality and safety of routine clinical CT assessment of bone health, these methods could enable opportunistic assessment of osteoporosis from CT images acquired during unrelated imaging procedures.

### 1.1 Existing Approaches

Multiple approaches have been proposed for the task of medical image super-resolution. These include sparsity-based models (i.e., compressive sensing) and data-driven models. From the latter category, deep neural networks have emerged as an effective and computationally efficient method for image reconstruction and super-resolution. These models take advantage of highly parallel GPU architectures to decrease computation time and achieve high performance on a range of image processing tasks, including image segmentation, image generation, and image upsampling.

Common approaches to image upsampling include a variety of convolutional neural networks (CNNs) and, more recently, generative adversarial networks (GANs) to achieve state-of-the-art image quality [5, 33]. Both approaches suffer from specific drawbacks. CNN approaches for super-resolution are known to exhibit a loss of sharp detail in the produced images, a phenomenon known as texture smoothing. While GAN models have demonstrated near-photorealistic results in large image datasets, they too come with downsides. These include model instability and mode collapse: unwanted model behavior in which the diversity of generator outputs is significantly less than the diversity of the training data [34]. In practice, this often means the model performs well on common inputs but very poorly on uncommon data. In medical data processing, mode collapse is especially dangerous as uncommon image features—possibly indicative of pathology—take on an outsized importance.

Here, we present an alternative probabilistic deep learning model and investigate the feasibility of its application to super-resolution on undersampled images of the femur. We show that this model is capable of generating high resolution images that closely resemble the ground truth images across a range of visual, structural, and mechanical criteria.

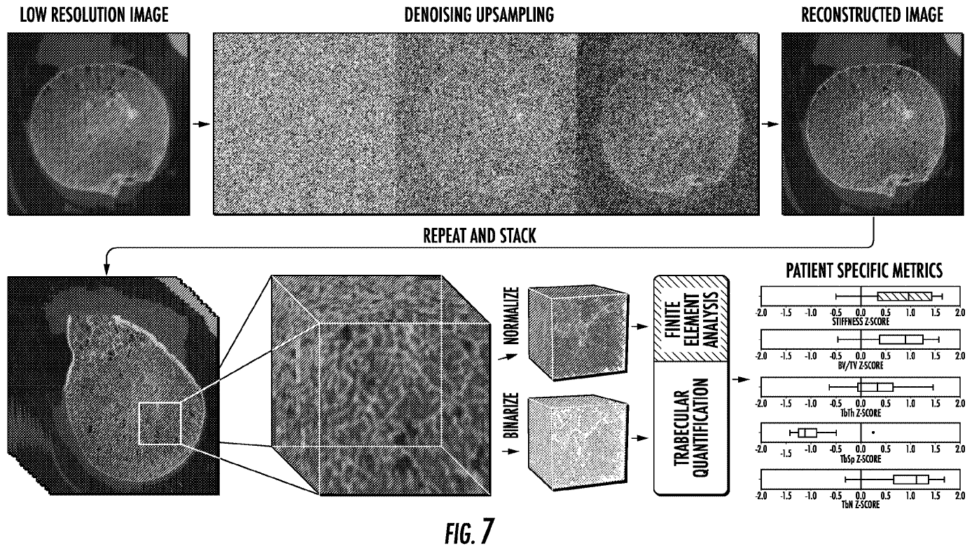

FIG. 7 illustrates an overview of the methodology described herein. In FIG. 7, low resolution slices from CT scans are upsampled and stacked to construct a detailed 3D image. From this image, we calculate microstructural and mechanical characteristics of the trabecular bone, which can be used to describe a patient's bone health status.

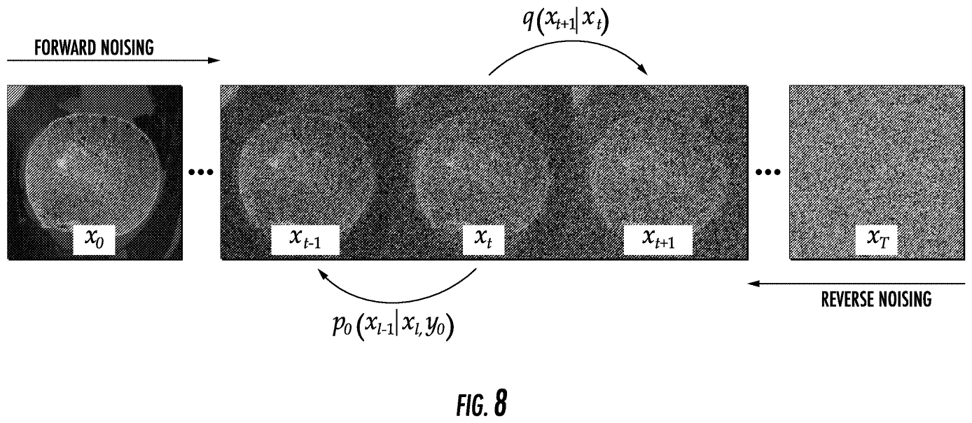

FIG. 8 illustrates that noising in the forward direction starts with a high resolution image x₀ and progresses towards x_{T} through the repeated addition of gaussian noise according to the process q. Reverse noising starts at random noise x_{T} and progresses towards x₀ via the process p_{θ}. Here, y₀ is the low resolution image to be upsampled.

### 1.2 Denoising Diffusion Probabilistic Models

Denoising diffusion probabilistic models (DDPM) were first described by [35] in 2015 but have recently garnered attention for their application to image generation and for improvements in image quality [7, 8, 9]. In 2021, [10] showed excellent results applying denoising diffusion models to image super-resolution on general image datasets. We adapt this class of model to perform upsampling on low resolution cadaveric femur CT images.

Creation of the diffusion model involves first defining a forward diffusion process of length T. Following [39, 42], we define the operation q as the gradual addition of Gaussian noise to an image x₀:

$$q ( {x}_{1 : T} \vert {x}_{0} ) := {\prod }_{t = 1}^{T} q ( {x}_{t} \vert {x}_{t - 1} ) , \qquad ( 1 )$$

$$q ( {x}_{t} \vert {x}_{t - 1} ) := 𝒩 ( {x}_{t} ; \sqrt{1 - {β}_{t}} {x}_{t - 1} , {β}_{t} I ) \qquad ( 2 )$$

and βₜ is a parameter that controls noise variance and is defined from 0<t≤T (FIG. 8). T and β are chosen such that x_{T} is essentially complete Gaussian noise. Also note that x₀ is the original denoised image.
Here, our goal is to learn a process p_{θ} that reverses the diffusion process q. As with the iterative process q, p_{θ} is broken into T steps:

$${p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

$${p}_{θ} ( {x}_{t - 1} \vert {x}_{t} ) := N ( {x}_{t - 1} ; {μ}_{θ} ( {x}_{t} , t ) , {σ}_{θ} ( {x}_{t} , t ) ) \qquad ( 4 )$$

A single step of this process p_{θ}(xₜ₋₁|xₜ) is modeled using a deep neural network. We adapt the SR3 architecture [10, 11] to model the process p_{θ}. This model consists of a U-net encoder-decoder with a ResNet backbone trained to remove a small, set amount of noise from an image. By repeating this process T times (T=2000), and optionally adding a low-resolution image y₀ as model conditional information (p_{θ}(xₜ₋₁|xₜ,y₀)) we can achieve both unconditional image generation and conditional image upsampling.

Training of the U-net model is performed using self-supervision. A single step of this process involves generating a low resolution prior y₀ and a noised image xₜ₋₁ from a high resolution image in the training dataset, as well as an 80 additional noise vector corresponding to the difference between adjacent time steps xₜ₋₁−xₜ(FIG. 14).

Following [7, 10], we optimize the variational bound of the negative log likelihood. In practice, this is accomplished by comparing steps of the forward process q to the modeled reverse process p_{θ} and minimizing the MSE:

$$L := {𝔼}_{t , {x}_{0} , ϵ} ( {‖ ϵ - {ϵ}_{θ} ( {x}_{t} , t ) ‖}^{2} ) \qquad ( 5 )$$

where ϵ_{θ} is the distribution of Gaussian noise removed by p_{θ} at step t and E is the known distribution of Gaussian noise added by q at step t.

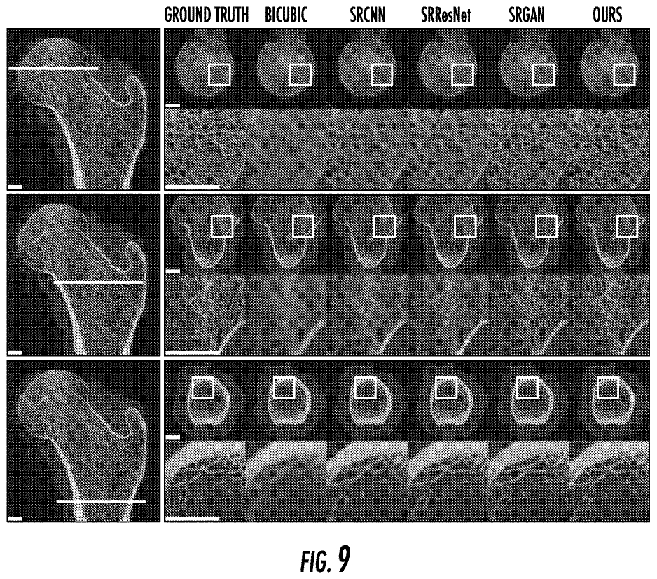

FIG. 9 illustrates a qualitative comparison of several deep learning upsampling methods. Ground truth images and representative reconstructions are shown for the femoral head, femoral neck, and femoral shaft. Enlarged views depicting detailed trabecular bone illustrate the texture smoothing behavior of CNN-based models and the advantages of our method in preserving image sharpness and network connectivity. The scale bar is 1 cm.

### 2 Results

Accurate analysis of the trabecular structure necessitates a higher resolution, and higher radiation dose, than is typically acquired clinically. For this reason, we trained these models on high resolution μCT scans of cadaveric specimens, initially acquired at 30 μm isotropic resolution and downsampled prior to use for model training. The resolution of the ground truth images in our dataset was 240 μm at a pixel count of 256². We bicubically downsampled these images by a factor of 3, to a spatial resolution of 720 μm at a pixel count of 85². The resolution of the downsampled images is comparable to that of clinically acquired resolutions [36, 37]. (See implementation details for more information.)

We compared performance against three established deep learning methods for image super-resolution. These included the super-resolution convolutional network (SRCNN [38]), super-resolution ResNet (SRResNet [25]), and the super-resolution GAN (SRGAN [39]). The choice of baselines was informed by [5]. While not specifically designed for applications to medical imaging, all three have been previously evaluated in tasks in medical imaging and have demonstrated high visual and quantitative performance improving CT images [5, 36].

An initial visual comparison of high resolution and model-reconstructed images showed that all models were able to recover some degree of detail over the bicubically interpolated low resolution images. Looking closely at the trabecular bone network, we saw a noticeable difference in image sharpness between the CNN and ResNet based models and the 100 GAN and diffusion based models (FIG. 9).

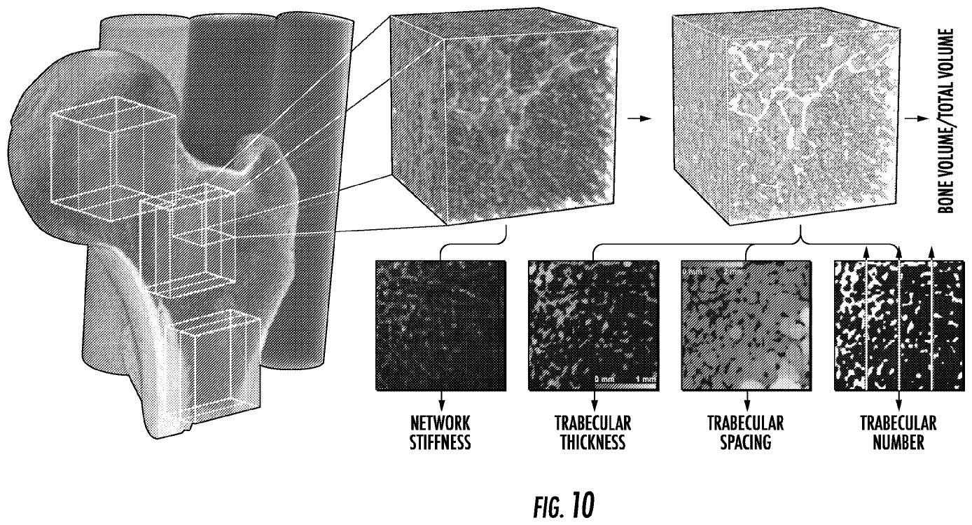

FIG. 10 illustrates examples of bone morphology measurements that can be produced from the super-resolution images produced using the methodology described herein. In FIG. 10, we selected 16 regions of interest (8 femoral head, 4 neck, 4 upper shaft) from each scan. We used the BoneJ ImageJ library to quantify 4 trabecular parameters and a finite element solver to calculate trabecular network stiffness [40, 41]. Bone parameter maps are visualized in the images in the lower right-hand side of FIG. 10. From left to right: the strain energy of an axial slice across the region, a trabecular thickness heatmap, a trabecular spacing heatmap, and an illustration of trabecular number.

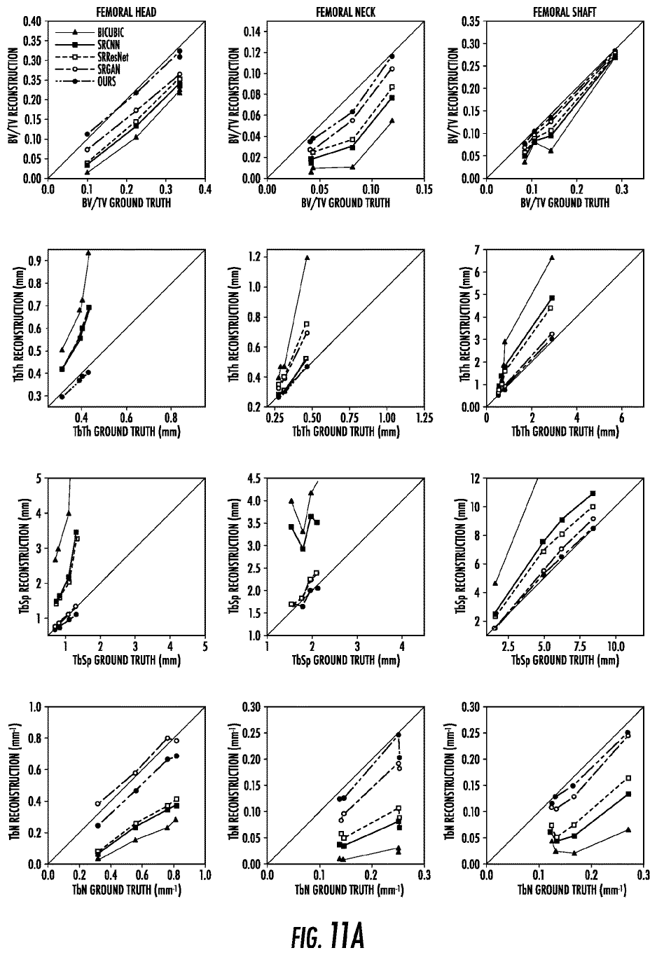

FIGS. 11A and 11B illustrate results of comparing five reconstruction methods across four trabecular microstructural parameters, over three regions of the proximal femur. FIG. 11A illustrates parameters calculated from reconstructed images are plotted against those calculated from the ground truth images. Points represent subjects from the test set. The gray line denotes perfect agreement. Intraclass correlation coefficients and Pearson's correlation coefficients are reported in Tables 5, 7. In FIG. 11B, the corresponding % errors are plotted with statistical significance determined by one-way ANOVA and post hoc Tukey test. *, ***, ****=p<=0.05, 0.01, 0.001, 0.0001. (n_{head}=32, n_{neck}=16, n_{shaft}=16)

### 2.1 Assessment of Trabecular Microstructure

In addition to a qualitative visual comparison (FIG. 9), we evaluated model performance quantitatively by comparing the trabecular microstructure of the reconstructed images. For each scan in the test dataset, we selected 16 12×12×12 mm³ regions of interest containing only trabecular bone. This included 8 regions taken from the femoral head, 4 from the femoral neck, and 4 from the proximal femoral shaft (FIG. 10). Each region was binarized using a flat intensity threshold. We then calculated four trabecular microstructural metrics: bone volume/total volume (BV/TV), trabecular thickness (TbTh), trabecular spacing (TbSp), and trabecular number (TbN), using the BoneJ library [40]. (Full descriptions of each parameter can be found in methods section.)

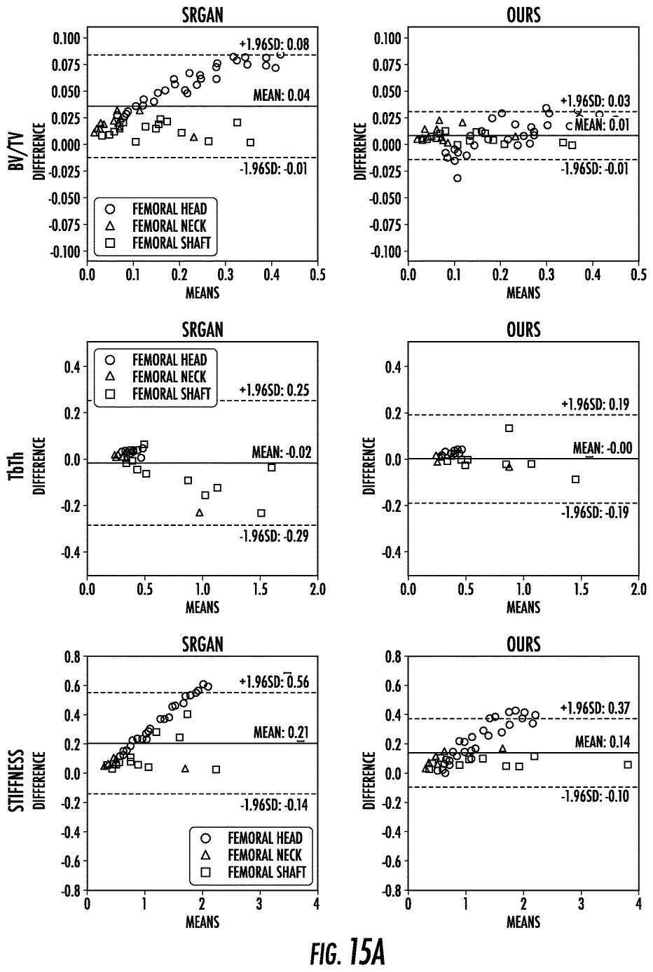

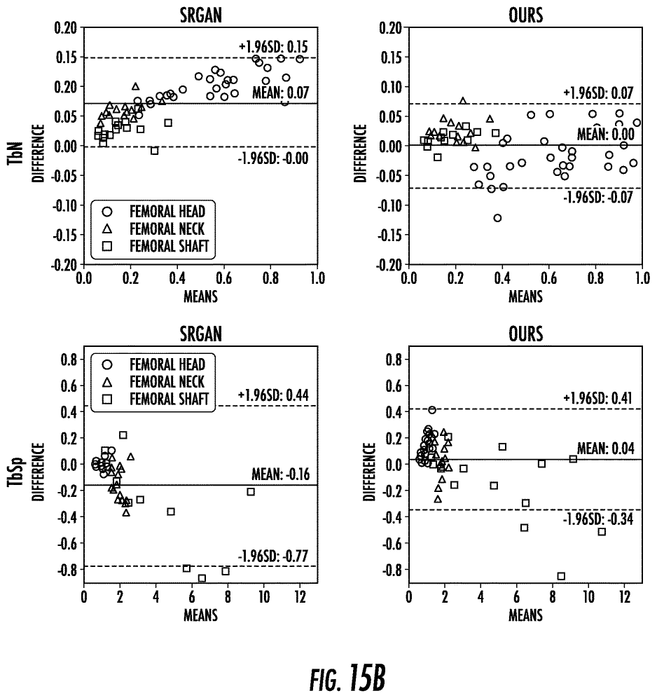

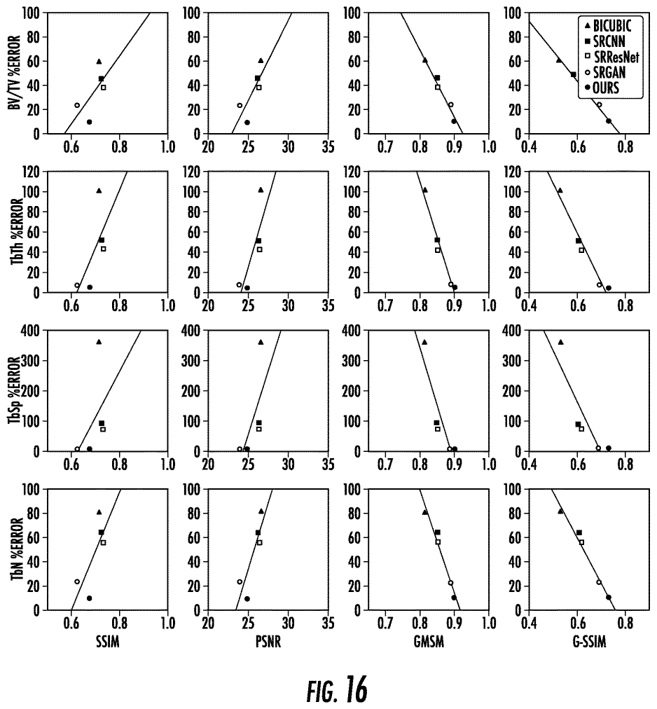

We found that our model was capable of consistent high reconstruction performance across a range of bone densities for various regions of the proximal femur. We plot the performance of our model, as well as the deep learning baselines, according to each trabecular parameter on a scatter plot (FIG. 5a). Comparing between methods, we calculated the percent error of each method for various parameters in the femoral head, neck, and shaft, and evaluated statistical significance with a one-way ANOVA and post hoc Tukey test (FIG. 11B). In nearly all cases, our method outperformed the baselines, and, in some cases, showed a significant decrease in percent error compared to the next best method, the SRGAN. We additionally calculated metrics of correlation for all models, including Intraclass correlation coefficients (ICC) and Pearson's correlation coefficients (Tables 5, 7), which likewise show high performance of our method in comparison to the baselines. A further Bland-Altman analysis of only the two highest performing models, ours and the SRGAN, shows that our model exhibits lower bias and variance compared to the GAN model (FIGS. 15A and 15B).

### 2.2 Assessment of Mechanical Stiffness

For each trabecular ROI, we also performed a finite element simulation and computed the region stiffness. Following [29], we first converted the grayscale Hounsfield unit matrix into a normalized bone density matrix and constructed a finite element model. We then used a finite element solver to estimate bone stiffness in the linear elastic regime in response to a uniaxial compressive load applied in the z-axis. We report axial stiffness.

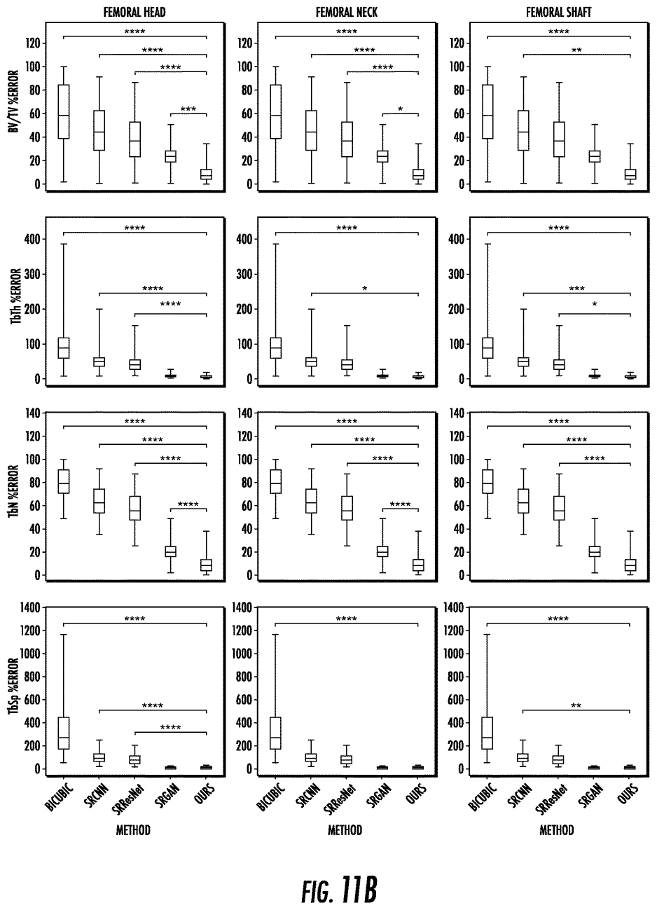

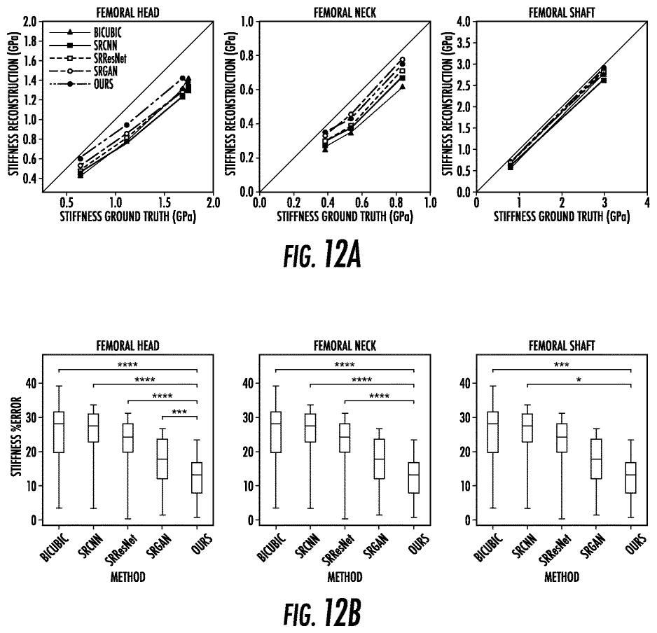

FIGS. 12A and 12B illustrate mechanical stiffness calculated by finite element analysis [41], compared across five reconstruction methods. In FIG. 12A reconstruction is plotted against ground truth, with the gray line denoting perfect agreement. Intraclass correlation coefficients and Pearson's correlation coefficients are reported in Tables 6, 8. In FIG. 12B, the corresponding % errors are plotted with statistical significance determined by one-way ANOVA and post hoc Tukey test. *, ***, ****=p<=0.05, 0.01, 0.001, 0.0001. (n_{head}=32, n_{neck}=16, n_{shaft}=16)

As with the calculation of trabecular microstructural parameters, our model demonstrated high performance reconstructing images that reiterated the mechanical properties of the ground truth images. Across a range of femur regions, our model consistently achieved a lower percent error than the baselines and, in the region of the femoral head, a significant decrease in percent error compared to the next best method, again the SRGAN (p<0.0001) (FIGS. 12A and 12B). As with the measures of trabecular structure, we calculate ICC and Pearson's correlation coefficients, as well as perform a Bland-Altman analysis for each of the methods for estimated stiffness (Tables 6, 8, FIGS. 15A and 15B). On average, our model was capable of estimating mechanical stiffness to within 15% of the ground truth value from an image one third the resolution, double the accuracy of bicubic reconstruction.

### 2.3 Assessment of Image Quality

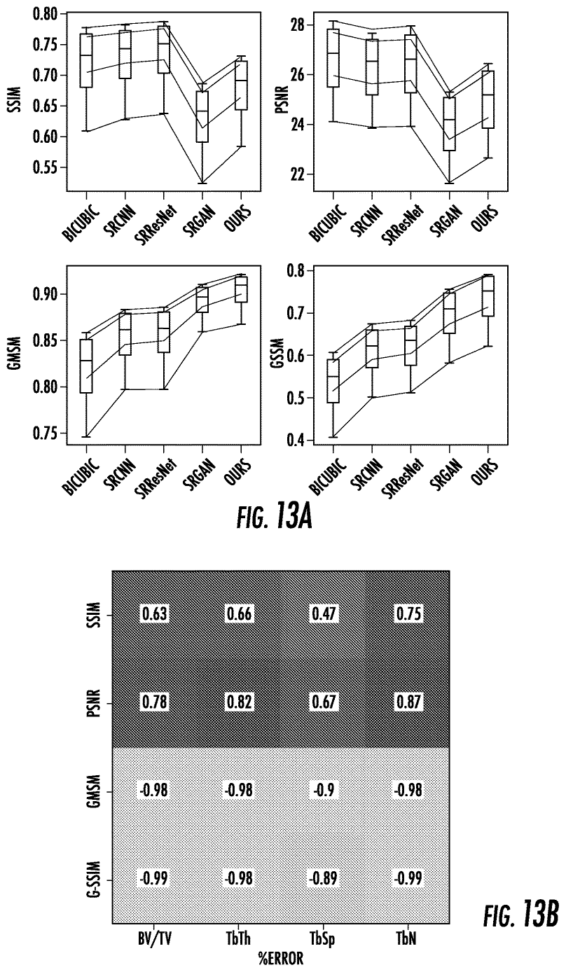

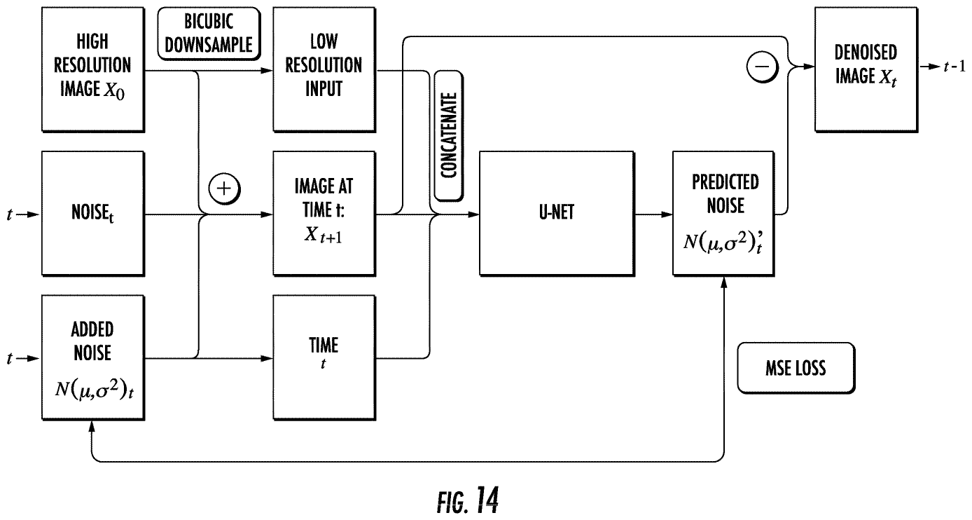

In addition to the five physiological parameters (four structural and one mechanical), we quantified the visual quality of the reconstructed images using a set of four image quality assessment (IQA) metrics (FIGS. 13A-13B). Counterintuitively, the GAN and DDPM methods which performed the highest according to the physiological metrics actually scored much lower on the two most commonly reported IQA metrics: peak signal-to-noise ratio (PSNR) and structural similarity (SSIM). Judging based on PSNR, the CNN methods (SRCNN and SRResNet) scored higher, but still fell short of simple bicubic interpolation. Considering SSIM, the CNN methods performed only marginally better than bicubic interpolation, though they were still considerably better than both the GAN and DDPM methods.

As these methods noticeably differ in the sharpness of the images produced, we calculated two additional IQA metrics that operate on the gradients of the image rather than the base intensity values. These are gradient magnitude similarity mean (GMSM) and gradient structural similarity (G-SSIM) [42, 43].

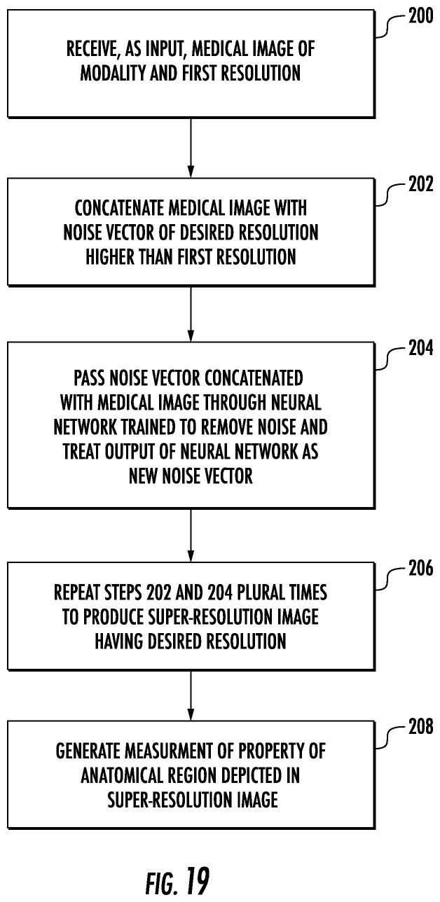

For both of these metrics, the pattern is reversed: models that perform well on physiological metrics likewise scored highly in these gradient-based image quality metrics, while models that fall short on physiological metrics scored poorly. By correlating reconstruction accuracy in structural parameters with reconstruction accuracy in IQA, we concluded that gradient structural similarity is the metric which best reflects performance in reconstructing useful physiological information (FIG. 19B).

### 2.4 Implications for Model Objectives and Evaluation

An explanation for the high comparative performance of the CNNs in common IQA metrics despite low visual and physiological performance can be found when considering the optimization criteria of these models. We first note that the task of recovering a high resolution image from a blurred image is ill-posed; plausible reconstructions of the original image lie in the posterior probability distribution p(x|y), with p(x) being the distribution of high-resolution images and y being the low resolution prior.

Both the SRCNN and SRResNet explicitly estimate the expected value of this distribution E[p(x|y)], a consequence of minimizing the mean squared error between the original and reconstructed image in the objective function. As such, they achieve high scores on the PSNR metric, which is inversely proportional to the log of mean squared error. In contrast, both the GAN and the DDPM implemented here seek to draw samples from the posterior distribution rather than estimate its mean. They do this differently: GANs utilize a discriminator network to implicitly learn a model of the original data distribution (here, the distribution of high resolution images p(x)), and seek to output images consistent with this learned distribution. DDPMs explicitly model the original data distribution with a learned score function, allowing a probabilistic sampling of the distribution at inference.

This difference in model objectives becomes apparent when the expected value E[p(x|y)] lies far outside the initial data distribution p(x). In images of trabecular bone, characterized by numerous small, complex features, sharp detail, and high contrast, there exists considerable uncertainty over the exact boundary of trabeculae in the image. The mean of probable outputs blurs these boundaries, producing the texture smoothing artifact in the final output, and resulting in a trabecular bone network that is physiologically implausible. In contrast, samples drawn from the posterior distribution p(x|y) are consistent with the initial distribution of images p(x). Individually, these sampled images cluster about the mean while still containing physiologically plausible trabecular networks.

### 3 Discussion

We used a probabilistic deep learning model to upsample low-resolution CT of the proximal femur and recover trabecular detail from low resolution images. We achieved high accuracy across a range of visual, structural, and mechanical parameters when analyzing highly detailed regions of trabecular bone. A comparison of our model's performance with three alternative deep learning models for image upsampling showed improved accuracy across all physiological metrics.

By comparing five trabecular reconstruction techniques using a range of physiological and image quality metrics, we concluded that the two most popular metrics for assessing image reconstruction performance, peak signal-to-noise ratio and structural similarity, have limited physiological relevance in the task of reconstructing detailed trabecular bone. However, two additional visual comparison metrics, gradient magnitude similarity mean and gradient structural similarity, correlated strongly with physiological reconstruction accuracy for trabecular bone. Based on these findings, we argue that the objective of most proposed deep learning models for medical image refinement is misplaced. Instead of estimating the mean of all probable output images, models should seek to sample a high probability image from the range of probable outputs.

This work has numerous applications, both scientific and clinical. Using this approach, it is possible to obtain detailed structural and mechanical information with a drastically reduced radiation dose. As the application of this method is not limited to peripheral sites, it is well suited to investigating the long-term effect of osteoporosis and specific interventions 186 on bone microstructure in the spine and hip. Clinically, the algorithms described here could be valuable both for improving the accuracy of osteoporosis diagnosis and for assessing the rate of osteoporosis progression, something that current methods struggle to do accurately. Overall, these methods add to existing methods of osteoporosis assessment and represent a step towards implementing opportunistic assessments of trabecular microstructure in the central skeleton from routine clinical CT.

### 4 Methods

### 4.1 3D Reconstruction and Selection of Trabecular ROIs

Upsampling of the images for all models occurred on 2D axial slices. Reconstructed 3D models were created from taking a z-stack of reconstructed images with an initial z resolution of 720 μm and performing a bilinear interpolation along the z axis. The final 3D images had an isotropic resolution of 240 μm. From these images, we selected 8 regions of interest each from the femoral head and 4 each from the femoral neck and shaft, totaling 16 per scan (FIG. 4. All regions were fully embedded in the trabecular bone (i.e., contain no cortical bone). Regions were 12×12×12 mm³ cubes.

### 4.2 Calculation of Trabecular Microstructural Parameters

Trabecular bone ROIs were first binarized using a flat intensity threshold. This threshold was chosen such that the bone volume fraction of the ground truth images was consistent with prior reported values [4]. We computed four trabecular parameters for each binarized region of interest. Bone volume fraction (BV/TV) was calculated as the number of occupied voxels over the number of total voxels. Trabecular thickness (TbTh) is an average of trabeculae thickness computed in 3D over the entire network. Trabecular spacing (TbSp) is the same, computed over the vacancy network of the binary region. Trabecular number (TbN) is estimated with

$$TbN = \frac{BV}{TV}$$

and represents the frequency of encountering a new trabeculae while traveling along a linear path through the network. We computed BV/TV, TbTh, and TbSp using the BoneJ plugin for ImageJ [40].

### 4.3 Calculation of Mechanical Properties

We used a finite element simulation to estimate the mechanical stiffness of trabecular bone ROIs in response to an axially applied load. Voxel intensity of the 3D images—initially in Houndsfield units—is first scaled in order to estimate the bone volume fraction map ranging from 0 (no bone) to 1 (all bone) following [25]. From this resulting 3D matrix, we created a finite element model composed of hexahedral finite elements equal in size and shape to voxels of the image. Following empirical values determined in previous studies, we assigned the tissue moduli for bone to be 15 GPa and the Poisson ratio to be 0.3 [25]. Tissue modulus for each finite element in our model was determined by linearly scaling the tissue modulus for complete bone with the element's estimated bone volume fraction.

We simulated a compressive axial loading of the model in the linear elastic regime [26, 27]. Element vertices lying on the lateral edges of the region were constrained, allowing 2 degrees of freedom. Models were solved by minimizing the total strain energy of the system. Axial stiffness was calculated as the ratio of axial stress over the loading surface to axial strain of the volume.

### 4.4 Data Acquisition and Preparation

The ex-vivo data used in this experiment was obtained using HR-pQCT imaging of 26 human cadaveric femurs (14 male and 12 female) at isotropic 30 μm resolution. Ages of the subjects at time of death ranged from 36 years to 99 years, with a mean age of 73 years. Together, they amount to 91,000 cross sectional bone images. At training, we used a bilinear down-sample operation to obtain a spatial resolution of 240 μm at a pixel count of 256². This was considered the ground truth image. For model inputs, we further down-sampled using bicubic interpolation to obtain a spatial resolution of 720 μm at a pixel count of 85². To evaluate model performance, we compared the ground truth image at 1 px=240² μm² and the generated image at the same resolution. We divided the 26 scans into training, validation, and testing partitions comprising 77%, 8%, and 15% of the available data respectively, or 20, 2, and 4 scans.

### 4.5 Baseline Model Implementation

We implemented three alternative deep learning super-resolution models: SRCNN, SRResNet, and SRGAN [38, 39]. All three have demonstrated high performance in image super-resolution across a range of image datasets, including in medical imaging tasks [13]. We choose them as benchmark architectures for comparing against CNN-based and GAN-based super-resolution models, while acknowledging that recent works in the field of computer vision and works specific to medical image reconstruction have reported superior performance compared to these base models in specific imaging tasks. Implementation of all baseline models used code adapted from public github repositories with slight adjustments for running on one channel images at the desired upsampling factors. Hyperparameters were kept at recommended settings. Identical data partitions were used for training, validation, and testing on these models as for the showcased diffusion model. All baseline models were trained until performance on the validation set plateaued or the recommended number of training epochs had been completed, whichever came second.

### 4.6 Statistical Tests

We used multiple statistical tests to validate the significance of our results. In analyzing differences in error between reconstruction models (FIGS. 11A, 11B, 12A, and 12B), we conducted a one-way ANOVA and post hoc Tukey test. We additionally compared correlations between model performance and ground truth across trabecular and mechanical properties using both Intraclass correlation coefficients and Pearson's correlation coefficients (Tables 5-8). Intraclass correlation coefficients were calculated using the ICC(2,k) standard, assuming two-way random raters, average measures, and absolute agreement. Finally, we performed a Bland-Altman analysis comparing performance of our model with the next highest performing model, the SRGAN (FIGS. 15A and 15B). Statistical tests were performed using the python pandas, scipy, statsmodels, and pingouin statistics libraries.

TABLE 2
We selected 16 regions of interest (8 femoral head, 4 neck,
4 upper shaft) from each scan. We used the BoneJ ImageJ library
to quantify 4 trabecular parameters and a finite element
solver to calculate trabecular network stiffness [41].

| | BV/TV | TbTh | TbS | TbN | Z Stiffness |
|---|---|---|---|---|---|
| Method | % Error | % Error | % Error | % Error | % Error |
| Bicubic | 60.14 | 101.0 | 362.2 | 81.34 | 25.81 |
| SRCNN | 45.20 | 51.92 | 93.15 | 64.60 | 25.33 |
| [38] | | | | | |
| SRResNet | 38.19 | 42.83 | 73.74 | 56.88 | 22.30 |
| [39] | | | | | |
| SRGAN | 23.29 | 7.456 | 7.170 | 23.04 | 17.20 |
| [39] | | | | | |
| DDPM | 9.286 | 4.558 | 7.031 | 10.18 | 12.30 |
| (ours) | | | | | |

Highest performing methods are bolded.

TABLE 3
Five reconstruction methods were compared on the basis of four
image quality assessment metrics: structural similarity (SSIM),
peak signal-to-noise ratio (PSNR), gradient magnitude similarity
mean (GMSM) [42], and gradient structural similarity (G-SSIM)

| Method | PSNR | SSIM | GMSM | G-SSIM |
|---|---|---|---|---|
| Bicubic | 26.51 | 0.714 | 0.815 | 0.529 |
| SRCNN [38] | 26.19 | 0.724 | 0.851 | 0.607 |
| SRResNet | 26.29 | 0.732 | 0.852 | 0.690 |
| [39] | | | | |
| SRGAN [39] | 23.85 | 0.624 | 0.890 | .0616 |
| DDPM (ours) | 24.86 | 0.675 | 0.901 | 0.730 |

Highest performing methods are bolded.

FIGS. 13A and 13B illustrate results of the comparison of five reconstruction methods on the basis of four image quality assessment metrics: structural similarity (SSIM), peak signal-to-noise ratio (PSNR), gradient magnitude similarity mean (GMSM) [42], and gradient structural similarity (GSSIM). (A) Light gray lines depict metric averages for a single test subject. (B) We show that only GSSIM and GMSM correlate with accuracy in the measured trabecular microstructural parameters (are anti-correlative with metric error).

TABLE 4
Values for trabecular bone microstructural parameters
derived over various regions of the proximal femur,
for a range of reconstruction approaches.

| | | | | |
|---|---|---|---|---|
| Method | BV/TV | TbTh (mm) | TbSp (mm) | TbN (mm⁻¹) |

Femoral Head

| | | | | |
|---|---|---|---|---|
| Ground | 0.2493 | 0.3854 | 0.9934 | 0.6185 |
| Truth | | | | |
| Bicubic | 0.1414 | 0.7097 | 4.4883 | 0.1751 |
| SRCNN | 0.1614 | 0.5700 | 2.1714 | 0.2570 |
| SRResNet | 0.1727 | 0.5656 | 2.0538 | 0.2781 |
| SRGAN | 0.1937 | 0.3563 | 0.9952 | 0.5164 |
| DDPM (ours) | 0.2394 | 0.3625 | 0.8689 | 0.6342 |

Femoral Neck

| | | | | |
|---|---|---|---|---|
| Ground | 0.0357 | 0.1681 | 0.9252 | 0.0987 |
| Truth | | | | |
| Bicubic | 0.0101 | 0.3138 | 6.4217 | 0.0089 |
| SRCNN | 0.0176 | 0.2391 | 1.9815 | 0.0278 |
| SRResNet | 0.0209 | 0.2201 | 1.6854 | 0.0379 |
| SRGAN | 0.0266 | 0.1721 | 1.0131 | 0.0687 |
| DDPM (ours) | 0.0316 | 0.1671 | 0.9223 | 0.0867 |

Femoral Shaft

| | | | | |
|---|---|---|---|---|
| Ground | 0.0775 | 0.6097 | 2.6472 | 0.0868 |
| Truth | | | | |
| Bicubic | 0.0563 | 1.4806 | 6.1386 | 0.0193 |
| SRCNN | 0.0636 | 1.0578 | 3.7548 | 0.0371 |
| SRResNet | 0.0672 | 0.9594 | 3.4097 | 0.0455 |
| SRGAN | 0.0708 | 0.6697 | 2.8799 | 0.0733 |
| DDPM (ours) | 0.0745 | 0.6367 | 2.7021 | 0.0805 |

Ground truth measurements are bolded.

TABLE 5
Intraclass correlation coefficients (ICC) calculated for various
reconstruction models against ground truth measurements,
for four trabecular bone microstructural parameters derived
over various regions of the proximal femur. ICC calculations
used the ICC2k standard: Average random raters.

| | | | | |
|---|---|---|---|---|
| Method | BV/TV | TbTh (mm) | TbSp (mm) | TbN (mm⁻¹) |

Femoral Head

| | | | | |
|---|---|---|---|---|
| Bicubic | 0.3555 | 0.0721 | 0.0063 | 0.0388 |
| SRCNN | 0.4292 | 0.1269 | 0.0190 | 0.0626 |
| SRResNet | 0.5018 | 0.1281 | 0.0292 | 0.0715 |
| SRGAN | 0.6090 | 0.6831 | 0.9929 | 0.5503 |
| DDPM (ours) | 0.9778 | 0.7547 | 0.5817 | 0.9710 |

Femoral Neck

| | | | | |
|---|---|---|---|---|
| Bicubic | 0.5714 | 0.4989 | −0.0002 | 0.0468 |
| SRCNN | 0.7660 | 0.7342 | 0.0186 | 0.1426 |
| SRResNet | 0.8382 | 0.8182 | 0.0024 | 0.2328 |
| SRGAN | 0.9225 | 0.9838 | 0.7058 | 0.5128 |
| DDPM (ours) | 0.9831 | 0.9987 | 0.9596 | 0.8812 |

Femoral Shaft

| | | | | |
|---|---|---|---|---|
| Bicubic | 0.8471 | 0.4515 | 0.3014 | 0.1359 |
| SRCNN | 0.9301 | 0.7083 | 0.8295 | 0.3876 |
| SRResNet | 0.9610 | 0.7806 | 0.9124 | 0.5458 |
| SRGAN | 0.9827 | 0.9812 | 0.9903 | 0.9465 |
| DDPM (ours) | 0.9962 | 0.9953 | 0.9991 | 0.9884 |

Highest performing correlations are bolded.

TABLE 6
Intraclass correlation coefficients (ICC) calculated for
various reconstruction models against ground truth measurements,
for trabecular bone stiffness calculated over various
regions of the proximal femur. ICC calculations used
the ICC2k standard: Average random raters.

| | Stiffness | | |
|---|---|---|---|
| Method | Femoral Head | Femoral Neck | Femoral Shaft |
| Bicubic | 0.6207 | 0.8253 | 0.9679 |
| SRCNN | 0.5104 | 0.8974 | 0.9699 |
| SRResNet | 0.5673 | 0.9288 | 0.9835 |
| SRGAN | 0.5549 | 0.9743 | 0.9618 |
| DDPM (ours) | 0.7620 | 0.9650 | 0.9939 |

Highest performing correlations are bolded.

TABLE 7
Pearson's correlation coefficients calculated for various
reconstruction models against ground truth measurements,
for four trabecular bone microstructural parameters derived
over various regions of the proximal femur.

| | | | | |
|---|---|---|---|---|
| Method | BV/TV | TbTh (mm) | TbSp (mm) | TbN (mm⁻¹) |

Femoral Head

| | | | | |
|---|---|---|---|---|
| Bicubic | 0.9942 | 0.9335 | 0.9190 | 0.9970 |
| SRCNN | 0.9986 | 0.9840 | 0.9585 | 0.9986 |
| SRResNet | 0.9993 | 0.9715 | 0.9526 | 0.9955 |
| SRGAN | 0.9999 | 0.9957 | 0.9996 | 0.9982 |
| DDPM (ours) | 0.9982 | 0.9913 | 0.9946 | 0.9920 |

Femoral Neck

| | | | | |
|---|---|---|---|---|
| Bicubic | 0.8983 | 0.9910 | 0.4993 | 0.9397 |
| SRCNN | 0.9582 | 0.9949 | 0.4940 | 0.9745 |
| SRResNet | 0.9601 | 0.9993 | 0.3417 | 0.9416 |
| SRGAN | 0.9907 | 0.9955 | 0.9640 | 0.9941 |
| DDPM (ours) | 0.9850 | 0.9986 | 0.8676 | 0.9524 |

Femoral Shaft

| | | | | |
|---|---|---|---|---|
| Bicubic | 0.9733 | 0.9759 | 0.9574 | 0.7571 |
| SRCNN | 0.9923 | 0.9829 | 0.9913 | 0.9326 |
| SRResNet | 0.9951 | 0.9870 | 0.9920 | 0.9596 |
| SRGAN | 0.9994 | 0.9996 | 0.9986 | 0.9913 |
| DDPM (ours) | 0.9995 | 0.9999 | 0.9988 | 0.9976 |

Highest performing correlations are bolded.

TABLE 8
Pearson's correlation coefficients calculated for various reconstruction
models against ground truth measurements, for trabecular bone stiffness
calculated over various regions of the proximal femur.

| | Stiffness | | |
|---|---|---|---|
| Method | Femoral Head | Femoral Neck | Femoral Shaft |
| Bicubic | 0.9965 | 0.9941 | 0.9996 |
| SRCNN | 0.9983 | 0.9911 | 0.9997 |
| SRResNet | 0.9988 | 0.9876 | 0.9997 |
| SRGAN | 0.9999 | 0.9974 | 0.9997 |
| DDPM (ours) | 0.9964 | 0.9903 | 0.9998 |

Highest performing correlations are bolded.

FIG. 14 illustrates an exemplary model architecture and training of the model to produce higher resolution images from lower resolution medical images. We trained the U-net in a self-supervised manner. We start with a high resolution image and a time t sampled from a uniform random distribution. We downsampled to obtain the low resolution prior and generate the corresponding noise at time t and the noise added between t and t+1. The model receives the low resolution image, the noised image, and the current timestep as inputs and predicts the noise added between steps t and t+1.

FIGS. 15A and 15B illustrate a Bland-Altman comparison of our method and the next highest performing method, the SRGAN, with ground truth shows an overall reduction in bias and variance of our method evaluated across four trabecular microstructural metrics and mechanical stiffness.

FIG. 16 illustrates image quality assessment metrics compared to trabecular structural metrics. Accuracy on trabecular physiological metrics was roughly inversely correlative with performance according to the two most common image quality assessment metrics: structural similarity (SSIM) and peak signal-to-noise ratio (PSNR), when evaluated over five reconstruction methods. Physiological metric accuracy correlated highly with image quality when assessed using the gradient magnitude similarity mean score (GMSM) or gradient-structural similarity (G-SSIM).

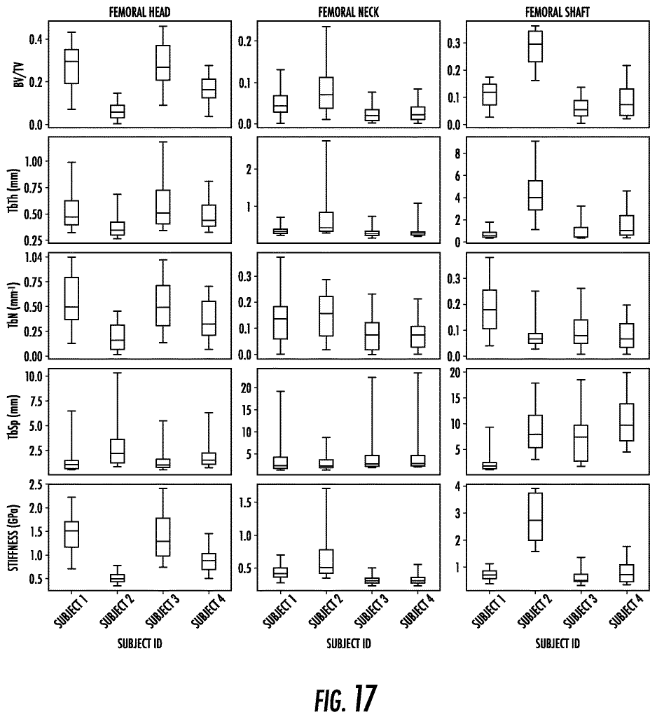

FIG. 17 illustrates physiological metrics calculated by region and by subject. We plot the structural and mechanical metric scores for each subject in our testing set. They exhibited a wide range of trabecular bone densities and mechanical stiffness.

### Exemplary Computer Implementation

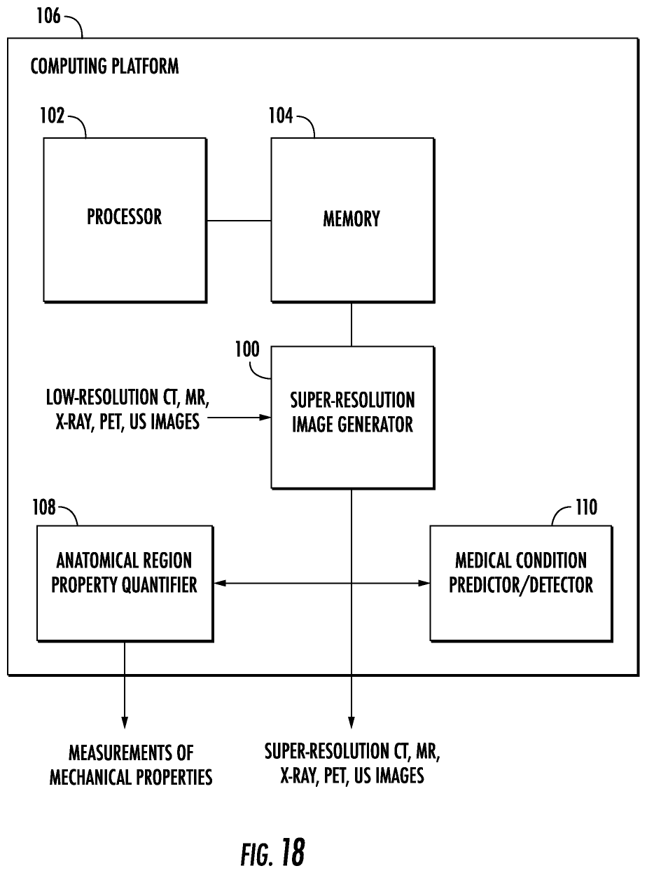

FIG. 18 is a block diagram illustrating an exemplary computer implementation of the super-resolution image generator described herein. Referring to FIG. 18, a super-resolution image generator 100 may be implemented using computer executable instructions stored in memory 102 and executed by processor 104 of computing platform 106. Super-resolution image generator may be a trained neural network, such as that illustrated in FIG. 2, that receives as input, low resolution CT, MR, PET, or ultrasound (US) images, concatenates the images with noise vectors, and iteratively processes the images to remove noise, for example, until a desired signal to noise ratio is reached. In one example, computing platform 106 may be a general purpose computing platform, such as a personal computer, a tablet, or a mobile phone, and super-resolution image generator 100 may be an application program that executes on computing platform 106. In another example, computing platform 106 may be a server, and super-resolution image generator 100 may be an application that executes on the server to allow users to submit low resolution images over a network interface, such as a web interface and receive corresponding high resolution images as output. In yet another example, computing platform 106 may be the output processing stage of a medical imaging machine or device, such as an MR, CT, PET, or ultrasound (US) device.

Computing platform 106 may further include an anatomical region property quantifier 108 that receives as input the super-resolution images produce by super-resolution image generator 106 and generates as output measurements of physiological, structural, or mechanical properties of anatomical regions depicted in the super-resolution images. For example, if the anatomical regions depicted in the images include bones, the measurements of mechanical properties may include measurements of bone stiffness, such as network stiffness or trabecular thickness, trabecular spacing, trabecular number, bone volume/total volume, etc. The measurements of physiological, structural, or mechanical properties may be calculated using finite element analysis, as described above.

Computing platform 106 may further include a medical condition detector/predictor 110 for using the super-resolution image to detect a current medical condition or predict a future medical condition of the subject. Implementation details of medical condition predictor/detector 110 are provided below.

FIG. 19 is a flow chart illustrating an exemplary process for super-resolution processing of medical images. Referring to FIG. 19, in step 200, the process includes receiving, as input, a medical image of a modality and a first resolution. For example, super-resolution image generator 100 may receive as input, low resolution MR, CT, PET, x-ray, or US images. The medical images may be of bones or any other anatomical structure.

In step 202, the process further includes concatenating the medical image with a noise vector of a desired resolution higher than the first resolution. For example, super-resolution image generator 100 may generate a noise vector, such as a Gaussian noise vector having the desired output pixel resolution.

In step 204, the process further includes passing the noise vector concatenated with the medical image though a neural network trained to remove noise and treating an output of the neural network as a new noise vector. For example, super-resolution image generator 100 may include a trained neural network having the structure illustrated in FIG. 2 which receives as input the low resolution image concatenated with the noise vector and that produces as output an image with some of the noise removed from the input. In an alternate example, an image processing neural network other than the U-net encoder/decoder can be used without departing from the scope of the subject matter described herein. It should be noted that the methodology described herein can be used to train a neural network on any existing database of medical images, with or without high resolution images as ground truth data. In addition, it is not necessary that medical images used for training be from the same patient or subject. For example, images from one set of subjects can be used to train a neural network to generate super-resolution images from images of different sets of subjects.

In step 206, the process further includes repeating steps 202 and 204 a plurality of times to produce, an image output from the neural network which comprises a super-resolution version of the medical image having the desired resolution. For example, the output from the trained neural network may be used as a new noise vector which is concatenated with the low-resolution input image and fed back into the neural network. The process may be repeated, in one example, a predetermined number of times (2000 in the examples above) based on the number of iterations required to achieve a desired value of a loss function during training.

In step 208, the process includes generating a measurement of a mechanical property of an anatomical structure from the super-resolution image. For example, if the anatomical structures depicted in the images are bones, the measurements of mechanical properties may include measurements of bone stiffness, such as network stiffness or trabecular thickness, trabecular spacing, trabecular number, bone volume/total volume, etc. The measurements of mechanical properties may be calculated using finite element analysis, as described above.

According to another aspect of the subject matter described herein, the super-resolution image may be used to detect a current medical condition or predict a future medical condition of a subject. For example, if the super-resolution image is an image of a bone, the image may be used to detect current (prevalent) fractures in the bone or predict a likelihood of future (incident) bone fractures. The detection of current medical conditions can be achieved in two different ways using the generated super-resolution images-(1) visual inspection e.g., by an expert, or (2) automatic detection using another algorithm (e.g., a convolutional neural network such as a U-net). The training of such a network can be performed by using annotated images from patients with such a medical condition and healthy individuals. Prediction of future medical conditions can be achieved using an algorithm such as a deep-learning neural network alone as above or combining the super-resolution image with other patient-specific information (e.g., demographics, disease history, medications) through a hybrid model. Training and validation of such a model can be achieved by using data longitudinal outcome data obtained from medical records.

According to another aspect of the subject matter described herein, upsampling to produce the super-resolution image is performed in a slice-wise manner in order to obtain 3D super-resolution, rather than super-resolution on only 2D images.

According to another aspect of the subject matter described herein, post-processing steps (such as thresholding, interpolation, smoothing), as well as quantification methods can be applied to the super-resolution image.

The super-resolution methods described maintain physiological realism in the upsampled image (as opposed to only visual/perceptual realism on the computer vision super-resolution side). Physiological realism is achieved by validating super-resolution images with downstream quantification against a gold standard, e.g., original images from which the low resolution images are generated.

In one example, a peak signal-to-noise ratio (PSNR) may be used to validate image reconstruction fidelity. PSNR is an evaluation metric by which we assess image reconstruction fidelity. This is a pre-defined metric and is commonly used to compare methods of image upsampling and reconstruction, in which a ground truth image exists and can be compared to a reconstructed image.

The calculation of PSNR is essentially a log-scaled normalized mean-squared-error (MSE). On images, calculating MSE involves taking the sum of square of the pixel-wise difference over two images and dividing by the number of pixels. PSNR is then defined as 10*log(base10)((range of pixel values)\hat{ }2/MSE). As we use an 8 bit representation for our images, our pixel value range is 255. An example PSNR calculation from Wikipedia that may be used appears below.

$$MSE = \frac{1}{m n} {\sum }_{i = 0}^{m - 1} {{\sum }_{j = 0}}^{n - 1} {[ I ( i , j ) - K ( i , j ) ]}^{2} . \\ The P SNR ( in dB ) is defined as$$

$$\begin{matrix}PSNR = 10 \cdot {log}_{10} ( \frac{{MAX}_{I}^{2}}{MSE} ) \\ = 20 \cdot {log}_{10} ( \frac{{MAX}_{I}}{\sqrt{MSE}} ) \\ = 20 \cdot {log}_{10} ( {MAX}_{I} ) - 10 \cdot {log}_{10} ( MSE )\end{matrix} .$$

We only use PSNR to assess the validation and testing accuracy in our model. We don't use PSNR to calculate model losses, so it is not calculated or used for adjusting parameters of the model during the iterative upsampling process. However, we do use the related MSE as a component of the loss function, which is calculated during training once per iteration.

The disclosure of each of the following references is incorporated herein by reference in its entirety.

### REFERENCES

[1] Akinori Hata, Masahiro Yanagawa, Osamu Honda, Noriko Kikuchi, Tomo Miyata, Shinsuke Tsukagoshi, Ayumi Uranishi, and Noriyuki Tomiyama, “Effect of matrix size on the image quality of ultra-high-resolution ct of the lung: comparison of 512×512, 1024×1024, and 2048×2048,” Academic radiology, vol. 25, no. 7, pp. 869-876, 2018.
[2] Masahiro Yanagawa, Akinori Hata, Osamu Honda, Noriko Kikuchi, Tomo Miyata, Ayumi Uranishi, Shinsuke Tsukagoshi, and Noriyuki Tomiyama, “Subjective and objective comparisons of image quality between ultra-high-resolution ct and conventional area detector ct in phantoms and cadaveric human lungs,” European radiology, vol. 28, no. 12, pp. 5060-5068, 2018.
[3] McDonnell, PE Mc Hugh, and D O'mahoney, “Vertebral osteoporosis and trabecular bone quality,” Annals of biomedical engineering, vol. 35, no. 2, pp. 170-189, 2007.
[4] Nicholas Mikolajewicz, Nick Bishop, Andrew J Burghardt, Lars Folkestad, Anthony Hall, Kenneth M Kozloff, Pauline T Lukey, Michael Molloy-Bland, Suzanne N Morin, Amaka C Offiah, et al., “Hr-pqct measures of bone microarchitecture predict fracture: systematic review and meta-analysis,” Journal of Bone and Mineral Research, vol. 35, no. 3, pp. 446-459, 2020.
[5] Y. Li, B. Sixou, and F. Peyrin, “A review of the deep learning methods for medical images super resolution problems,” IRBM, vol. 42, no. 2, pp. 120-133, 2021.
[6] Jascha Sohl-Dickstein, Eric Weiss, Niru Maheswaranathan, and Surya Ganguli, “Deep unsupervised learning using nonequilibrium thermodynamics,” in International Conference on Machine Learning. PMLR, 2015, pp. 2256-2265.
[7] Jonathan Ho, Ajay Jain, and Pieter Abbeel, “Denoising diffusion probabilistic models,” arXiv preprint arXiv:2006.11239, 2020.
[8] Alex Nichol and Prafulla Dhariwal, “Improved denoising diffusion probabilistic models,” arXiv preprint arXiv:2102.09672, 2021.
[9] Prafulla Dhariwal and Alex Nichol, “Diffusion models beat gans on image synthesis,” arXiv preprint arXiv:2105.05233, 2021.
[10] Chitwan Saharia, Jonathan Ho, William Chan, Tim Salimans, David J Fleet, and Mohammad Norouzi, “Image super-resolution via iterative refinement,” arXivpreprint arXiv:2104.07636, 2021.
[11] Liangwei Jiang, “Image super-resolution via iterative refinement, github repository,” 2021.
[12] Marshall et al., “Meta-analysis of how well measures of bone mineral density predict occurrence of osteoporotic fractures. Bmj 1996, 312(7041): p 1254-9
[13] Bruer et al., “Incidence and morality of hip fractures in the United States,” Jama 2009 302(14): p 1573-9
[14] Magaziner et al., “Changes in functional status attributable to hip fracture: a comparison of hip fracture patients to community-dwelling aged,” Am J Epidemiol, 2003, 157(11): p. 1023-31.
[15] Krug et al., “Feasibility of in vivo structural analysis of high-resolution magnetic resonance images of the proximal femur,” Osteoporosis Int, 2005 16(11): p. 1307-14.
[16] Han et al., “Variable flip angle three-dimensional fast spin-echo sequence combined with outer volume suppression for imaging trabecular bone structure of the proximal femur,” Journal of Magnetic Resonance Imaging: JMRI, 2015 41(5): p. 1300-1310.
[17] Rajapakse et al., “Patient-Specific Hip Fracture strength Assessment with Microstructural MR imaging-based Finite Element Modeling. Radiology, 2017. 283(3): p. 854-861.
[18] Rajapakse et al., “MRI-based assessment of proximal femur strength compared to mechanical testing,” Bone, 2020. 133: p. 115-227.
[19] Bau et al., “Seeing what a GAN Cannot Generate,” Proceedings of the IEEE/CVF International Conference on Computer Vision (ICCV), 2019, p. 4502-4511.
[20] Wang et al., “Recovering Realistic Texture in Image Super-Resolution by Deep Spatial Feature Transform, Proceedings of the IEEE Conference on Computer Vision and Pattern Recognition (CVPR), 2018, p. 606-615.
[21] Saha et al., “Measurement of trabecular bone thickness in the limited resolution regime of in vivo MRI by fizzy distance transform,” IEEE transactions on medical imaging. 2004 Jan. 7; 23(1):53-62
[22] Rajapakse et al., “The efficacy of low-intensity vibration to improve bone health in patients with end-stage renal disease is highly dependent on compliance and muscle response,” Academic radiology. 2017 Nov. 1; 24(11):1322-42.
[23] Deborah Marshall, Olof Johnell, and Hans Wedel. Meta-analysis of how well measures of bone mineral density predict occurrence of osteoporotic fractures. Bmj, 312(7041):1254-1259, 1996.
[24] Thomas Beck. Measuring the structural strength of bones with dual-energy x-ray absorptiometry: principles, technical limitations, and future possibilities. Osteoporosis International, 14(5):81-88, 2003.
[25] Ego Seeman and Pierre D Delmas. Bone quality—the material and structural basis of bone strength and fragility. New England journal of medicine, 354(21):2250-2261, 2006.
[26] Michael Kleerekoper, AR Villanueva, J Stanciu, D Sudhaker Rao, and AM Parfitt. The role of three-dimensional trabecular microstructure in the pathogenesis of vertebral compression fractures. Calcified tissue international, 37(6):594-597, 1985.
[27] Erick Legrand, Daniel Chappard, Christian Pascaretti, Marc Duquenne, Stéphanie Krebs, Vincent Rohmer, Michel-Félix Basle, and Maurice Audran. Trabecular bone microarchitecture, bone mineral density, and vertebral fractures in male osteoporosis. Journal of Bone and Mineral Research, 15(1):13-19, 2000.
[28] Felix W Wehrli, Punam K Saha, Bryon R Gomberg, Hee Kwon Song, Peter J Snyder, Maria Benito, Alex Wright, and Richard Weening. Role of magnetic resonance for assessing structure and function of trabecular bone. Topics in Magnetic Resonance Imaging, 13(5):335-355, 2002.
[29] Chamith S Rajapakse, Jeremy F Magland, Michael J Wald, X Sherry Liu, X Henry Zhang, X Edward Guo, and Felix W Wehrli. Computational biomechanics of the distal tibia from high-resolution mr and micro-ct images. Bone, 47(3):556-563, 2010.
[30] Kyle K Nishiyama and Elizabeth Shane. Clinical imaging of bone microarchitecture with hr-pqct. Current osteoporosis reports, 11(2):147-155, 2013.
[31] Cheng Chen, Xiaoliu Zhang, Junfeng Guo, Dakai Jin, Elena M Letuchy, Trudy L Burns, Steven M Levy, Eric A Hoffman, and Punam K Saha. Quantitative imaging of peripheral trabecular bone microarchitecture using mdct. Medical Physics, 45(1):236-249, 2018.
[32] Steven R Cummings and L Joseph Melton. Epidemiology and outcomes of osteoporotic fractures. The Lancet, 231359(9319):1761-1767, 2002.
[33] Chenyu You, Guang Li, Yi Zhang, Xiaoliu Zhang, Hongming Shan, Mengzhou Li, Shenghong Ju, Zhen Zhao, Zhuiyang Zhang, Wenxiang Cong, et al. Ct super-resolution gan constrained by the identical, residual, and cycle learning ensemble (gan-circle). IEEE transactions on medical imaging, 39(1):188-203, 2019.
[34] Hoang Thanh-Tung and Truyen Tran. Catastrophic forgetting and mode collapse in gans. In 2020 international joint conference on neural networks (ijcnn), pages 1-10. IEEE, 2020.
[35] Jascha Sohl-Dickstein, Eric Weiss, Niru Maheswaranathan, and Surya Ganguli. Deep unsupervised learning using nonequilibrium thermodynamics. In International Conference on Machine Learning, pages 2256-2265. PMLR, 2015.
[36] Eugene Lin and Adam Alessio. What are the basic concepts of temporal, contrast, and spatial resolution in cardiac ct? Journal of cardiovascular computed tomography, 3(6):403-408, 2009.
[37] Andrew J Burghardt, Thomas M Link, and Sharmila Majumdar. High-resolution computed tomography for clinical imaging of bone microarchitecture. Clinical Orthopaedics and Related Research®, 469(8):2179-2193, 2011.
[38] Chao Dong, Chen Change Loy, Kaiming He, and Xiaoou Tang. Image super-resolution using deep convolutional networks. IEEE transactions on pattern analysis and machine intelligence, 38(2):295-307, 2015.
[39] Christian Ledig, Lucas Theis, Ferenc Huszár, Jose Caballero, Andrew Cunningham, Alejandro Acosta, Andrew Aitken, Alykhan Tejani, Johannes Totz, Zehan Wang, et al. Photo-realistic single image super-resolution using a generative adversarial network. In Proceedings of the IEEE conference on computer vision and pattern recognition, pages 4681-4690, 2017.
[40] Michael Doube, Michat M Kkosowski, Ignacio Arganda-Carreras, Fabrice P Cordelières, Robert P Dougherty, Jonathan S Jackson, Benjamin Schmid, John R Hutchinson, and Sandra J Shefelbine. Bonej: free and extensible bone image analysis in imagej. Bone, 47(6):1076-1079, 2010.
[41] Jeremy F Magland, Ning Zhang, Chamith S Rajapakse, and Felix W Wehrli. Computationally-optimized bone mechanical modeling from high-resolution structural images. PloS one, 7(4):e35525, 2012.
[42] Wufeng Xue, Lei Zhang, Xuanqin Mou, and Alan C Bovik. Gradient magnitude similarity deviation: A highly efficient perceptual image quality index. IEEE transactions on image processing, 23(2):684-695, 2013.
[43] Guan-Hao Chen, Chun-Ling Yang, and Sheng-Li Xie. Gradient-based structural similarity for image quality assessment. In 2006 international conference on image processing, pages 2929-2932. IEEE, 2006.
[44] JS Bauer, S Kohlmann, F Eckstein, D Mueller, E-M Lochmuller, and T_{M} Link. Structural analysis of trabecular bone of the proximal femur using multislice computed tomography: a comparison with dual x-ray absorptiometry for predicting biomechanical strength in vitro. Calcified tissue international, 78(2):78-89, 2006.
[45] Chamith S Rajapakse, Mary B Leonard, Yusuf A Bhagat, Wenli Sun, Jeremy F Magland, and Felix W Wehrli. Micro-mr imaging-based computational biomechanics demonstrates reduction in cortical and trabecular bone strength after renal transplantation. Radiology, 262(3):912, 2012.
[46] J F Magland, CS Rajapakse, MJ Wald, B Vasilie, XE Guo, XH Zhang, and F W Wehrli. Grayscale mr image based finite element mechanical modeling of trabecular bone at in vivo resolution. In Journal of Bone and Mineral Research, volume 23, pages S310-S310. AMER SOC BONE & MINERAL RES 2025 M ST, NW, STE 800, 280 WASHINGTON, DC 20036 . . . , 2008.
[47] B Van Rietbergen, A Odgaard, J Kabel, and R Huiskes. Direct mechanics assessment of elastic symmetries and properties of trabecular bone architecture. Journal of biomechanics, 29(12):1653-1657, 1996.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for super-resolution processing of medical images, the method comprising:
(a) receiving, as input, a medical image of a modality and a first resolution;
(b) concatenating the medical image with a noise vector of a desired resolution higher than the first resolution;
(c) passing the noise vector concatenated with the medical image though a neural network trained to remove noise and treating an output of the neural network as a new noise vector for use as the noise vector in step (b); and
(d) repeating steps (b) and (c) a plurality of times to produce an image output from the neural network which comprises a super-resolution version of the medical image having the desired resolution.

2. The method of claim 1 wherein the modality is computed tomography (CT).

3. The method of claim 1 wherein the modality is magnetic resonance (MR).

4. The method of claim 1 wherein the modality is positron emission tomography (PET).

5. The method of claim 1 wherein the modality is ultrasound.

6. The method of claim 1 wherein the modality is x-ray

7. The method of claim 1 wherein the trained neural network comprises a U-Net encoder decoder with skip connections.

8. The method of claim 1 wherein the neural network implements a denoising diffusion probabilistic model (DDPM).

9. The method of claim 1 wherein repeating steps (b) and (c) a plurality of times includes repeating steps (b) and (c) a number of times based on a number of iterations required to achieve a desired value of a loss function during training of the neural network.

10. The method of claim 1 comprising generating a measurement of a physiological, structural, or mechanical property of an anatomical region depicted in the super-resolution image.

11. The method of claim 10 wherein the anatomical region comprises a bone and generating the measurement of the mechanical property is achieved using finite element analysis.

12. The method of claim 1 comprising using the super-resolution image to predict a future medical condition of the subject.

13. The method of claim 1 comprising using the super-resolution image to detect a current medical condition of the subject.

14. The method of claim 1 comprising performing steps (a)-(d) to generate a plurality of 2D super-resolution image slices to generate a 3D super-resolution image.

15. A system for super-resolution processing of medical images, the system comprising:
at least one processor; and
a super-resolution image generator implemented by the at least one processor for receiving, as input, a medical image of a modality and a first resolution, concatenating the medical image with a noise vector of a desired resolution higher than the first resolution, passing the noise vector concatenated with the medical image though a neural network trained to remove noise and treating an output of the neural network as a new noise vector for use as the noise vector, and repeating the concatenating and passing a plurality of times to produce an image output from the neural network which comprises a super-resolution version of the medical image having the desired resolution.

16. The system of claim 15 wherein the modality is computed tomography (CT).

17. The system of claim 15 wherein the modality is magnetic resonance (MR).

18. The system of claim 15 wherein the modality is positron emission tomography (PET).

19. The system of claim 15 wherein the modality is ultrasound.

20. The system of claim 14 wherein the modality is x-ray.

21. The system of claim 15 wherein the trained neural network comprises a U-Net encoder decoder with skip connections.

22. The system of claim 15 wherein the neural network implements a denoising diffusion probabilistic model (DDPM).

23. The system of claim 15 wherein repeating the concatenating and passing a plurality of times includes repeating the concatenating and passing a number of times based on a number of iterations required to achieve a desired value of a loss function during training of the neural network.

24. The system of claim 15 comprising an anatomical region property quantifier for generating a measurement of a physiological, structural, or mechanical property of an anatomical region depicted in the super-resolution image.

25. The system of claim 15 comprising a medical condition detector/predictor for using the super-resolution image to detect a current medical condition or predict a future medical condition of the subject.

26. The system of claim 15 wherein the super-resolution image generator is configured to generate a plurality of 2D super-resolution image slices of a 3D super-resolution image.

27. A non-transitory computer readable medium comprising computer executable instructions that when executed by a processor of a computer control the computer to perform the steps comprising:
receiving, as input, a medical image of a modality and a first resolution;
concatenating the medical image with a noise vector of a desired resolution higher than the first resolution;
passing the noise vector concatenated with the medical image though a neural network trained to remove noise and treating an output of the neural network as a new noise vector for use as the noise vector in step (b); and
repeating steps (b) and (c) a plurality of times to produce an image output from the neural network which comprises a super-resolution version of the medical image having the desired resolution.
